(19) United States
(12) Patent Application Publication
(10) Pub. No.: US 2011/0242138 A1
(43) Pub. Date: Oct. 6, 2011

(54) Device, Method, and Graphical User Interface with Concurrent Virtual Keyboards

(76) Inventor: Guy L. Tribble, Hillsborough, CA (US)

(21) Appl. No.: 12/752,003

(22) Filed: Mar. 31, 2010

(51) Int. Cl. G09G 5/00; G06F 3/041

(52) U.S. Cl. 345/663; 345/173

(57) ABSTRACT

A multifunction device with a touch-sensitive display concurrently displays a first virtual keyboard at a first location on the touch-sensitive display and a second virtual keyboard at a second location, distinct from the first location, on the touch-sensitive display. In response to detecting a first finger gesture on a first key in the first virtual keyboard, an action corresponding to the first key in the first virtual keyboard is performed. In response to detecting a second finger gesture on a second key in the second virtual keyboard, an action corresponding to the second key in the second virtual keyboard is performed.

### TECHNICAL FIELD

The disclosed embodiments relate generally to electronic devices with touch-sensitive surfaces, including but not limited to electronic devices with virtual keyboards.

### BACKGROUND

The use of touch-sensitive surfaces as input devices for computers and other electronic computing devices has increased significantly in recent years. Exemplary touch-sensitive surfaces include touch pads and touch screen displays. Such surfaces are widely used to manipulate user interface objects on a display.

Exemplary manipulations include activating keys (e.g., typing) with a virtual keyboard on the display. A user may need to use a virtual keyboard in a wide variety of applications, such as in a file management program (e.g., Finder from Apple Computer, Inc. of Cupertino, Calif.), an image management application (e.g., Aperture or iPhoto from Apple Computer, Inc. of Cupertino, Calif.), a digital content (e.g., videos and music) management application (e.g., iTunes from Apple Computer, Inc. of Cupertino, Calif.), a drawing application, a presentation application (e.g., Keynote from Apple Computer, Inc. of Cupertino, Calif.), a word processing application (e.g., Pages from Apple Computer, Inc. of Cupertino, Calif.), a website creation application (e.g., iWeb from Apple Computer, Inc. of Cupertino, Calif.), a disk authoring application (e.g., iDVD from Apple Computer, Inc. of Cupertino, Calif.), or a spreadsheet application (e.g., Numbers from Apple Computer, Inc. of Cupertino, Calif.).

But existing virtual keyboards are cumbersome and inefficient in many situations. For example, typing on a virtual keyboard on a large-form-factor portable device (e.g., a tablet device) while the device is held by hand is tedious and creates significant physical and cognitive burdens on a user. In addition, existing virtual keyboards take longer than necessary to use, thereby wasting energy. This latter consideration is particularly important in battery-operated devices.

### SUMMARY

Accordingly, there is a need for computing devices with faster, more efficient methods and interfaces for activating keys in virtual keyboards. Such methods and interfaces may complement or replace conventional methods for activating keys in virtual keyboards. Such methods and interfaces reduce the cognitive burden on a user and produce a more efficient human-machine interface. For battery-operated computing devices, such methods and interfaces conserve power and increase the time between battery charges.

The above deficiencies and other problems associated with user interfaces for computing devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch screen display”). In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive surface. In some embodiments, the functions may include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In accordance with some embodiments, a method is performed at a multifunction device with a touch-sensitive display. The method includes: displaying concurrently a first virtual keyboard at a first location on the touch-sensitive display and a second virtual keyboard at a second location, distinct from the first location, on the touch-sensitive display; detecting a first finger gesture on a first key in the first virtual keyboard; in response to detecting the first finger gesture on the first key in the first virtual keyboard, performing an action corresponding to the first key in the first virtual keyboard; detecting a second finger gesture on a second key in the second virtual keyboard; and, in response to detecting the second finger gesture on the second key in the second virtual keyboard, performing an action corresponding to the second key in the second virtual keyboard.

In accordance with some embodiments, a multifunction device includes a touch-sensitive display, one or more processors, memory, and one or more programs. The one or more programs are stored in the memory and configured to be executed by the one or more processors. The one or more programs include instructions for: displaying concurrently a first virtual keyboard at a first location on the touch-sensitive display and a second virtual keyboard at a second location, distinct from the first location, on the touch-sensitive display; detecting a first finger gesture on a first key in the first virtual keyboard; in response to detecting the first finger gesture on the first key in the first virtual keyboard, performing an action corresponding to the first key in the first virtual keyboard; detecting a second finger gesture on a second key in the second virtual keyboard; and, in response to detecting the second finger gesture on the second key in the second virtual keyboard, performing an action corresponding to the second key in the second virtual keyboard.

In accordance with some embodiments, a computer readable storage medium has stored therein instructions which when executed by a multifunction device with a touch-sensitive display, cause the device to: display concurrently a first virtual keyboard at a first location on the touch-sensitive display and a second virtual keyboard at a second location, distinct from the first location, on the touch-sensitive display; detect a first finger gesture on a first key in the first virtual keyboard; in response to detecting the first finger gesture on the first key in the first virtual keyboard, perform an action corresponding to the first key in the first virtual keyboard; detect a second finger gesture on a second key in the second virtual keyboard; and, in response to detecting the second finger gesture on the second key in the second virtual keyboard, perform an action corresponding to the second key in the second virtual keyboard.

In accordance with some embodiments, a graphical user interface on a multifunction device with a touch-sensitive display, a memory, and one or more processors to execute one or more programs stored in the memory includes a first virtual keyboard at a first location on the touch-sensitive display, and a second virtual keyboard at a second location, distinct from the first location, on the touch-sensitive display. A first finger gesture is detected on a first key in the first virtual keyboard. In response to detecting the first finger gesture on the first key in the first virtual keyboard, an action corresponding to the first key in the first virtual keyboard is performed. A second finger gesture is detected on a second key in the second virtual keyboard. In response to detecting the second finger gesture on the second key in the second virtual keyboard, an action corresponding to the second key in the second virtual keyboard is performed.

In accordance with some embodiments, a multifunction device includes: a touch-sensitive display; means for displaying concurrently a first virtual keyboard at a first location on the touch-sensitive display and a second virtual keyboard at a second location, distinct from the first location, on the touch-sensitive display; means for detecting a first finger gesture on a first key in the first virtual keyboard; in response to detecting the first finger gesture on the first key in the first virtual keyboard, means for performing an action corresponding to the first key in the first virtual keyboard; means for detecting a second finger gesture on a second key in the second virtual keyboard; and, in response to detecting the second finger gesture on the second key in the second virtual keyboard, means for performing an action corresponding to the second key in the second virtual keyboard.

In accordance with some embodiments, an information processing apparatus for use in a multifunction device with a touch-sensitive display includes: means for displaying concurrently a first virtual keyboard at a first location on the touch-sensitive display and a second virtual keyboard at a second location, distinct from the first location, on the touch-sensitive display; means for detecting a first finger gesture on a first key in the first virtual keyboard; in response to detecting the first finger gesture on the first key in the first virtual keyboard, means for performing an action corresponding to the first key in the first virtual keyboard; means for detecting a second finger gesture on a second key in the second virtual keyboard; and, in response to detecting the second finger gesture on the second key in the second virtual keyboard, means for performing an action corresponding to the second key in the second virtual keyboard.

Thus, multifunction devices with touch-sensitive displays are provided with faster, more efficient methods and interfaces for activating keys in virtual keyboards, thereby increasing the effectiveness, efficiency, and user satisfaction with such devices. Such methods and interfaces may complement or replace conventional methods for activating keys in virtual keyboards.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIGS. 1A and 1B are block diagrams illustrating portable multifunction devices with touch-sensitive displays in accordance with some embodiments.

FIG. 1C is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIGS. 4A and 4B illustrate exemplary user interfaces for a menu of applications on a portable multifunction device in accordance with some embodiments.

FIGS. 5A-5L illustrate exemplary user interfaces for activating keys in concurrent virtual keyboards in accordance with some embodiments.

FIGS. 6A-6D are flow diagrams illustrating a method of activating keys in concurrent virtual keyboards in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of computing devices, user interfaces for such devices, and associated processes for using such devices are described. In some embodiments, the computing device is a portable communications device, such as a mobile telephone, that also contains other functions, such as PDA and/or music player functions. Exemplary embodiments of portable multifunction devices include, without limitation, the iPhone® and iPod Touch® devices from Apple Inc. of Cupertino, Calif. Other portable devices, such as laptops or tablet computers with touch-sensitive surfaces (e.g., touch screen displays and/or touch pads), may also be used. It should also be understood that, in some embodiments, the device is not a portable communications device, but is a desktop computer with a touch-sensitive surface (e.g., a touch screen display and/or a touch pad).

In the discussion that follows, a computing device that includes a display and a touch-sensitive surface is described. It should be understood, however, that the computing device may include one or more other physical user-interface devices, such as a physical keyboard, a mouse and/or a joystick.

The device supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent to the user.

The user interfaces may include one or more soft keyboard embodiments. The soft keyboard embodiments may include standard (QWERTY) and/or non-standard configurations of symbols on the displayed icons of the keyboard, such as those described in U.S. patent application Ser. Nos. 11/459,606, “Keyboards For Portable Electronic Devices,” filed Jul. 24, 2006, and 11/459,615, “Touch Screen Keyboards For Portable Electronic Devices,” filed Jul. 24, 2006, the contents of which are hereby incorporated by reference in their entireties. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the device may utilize common and/or different keyboard embodiments. Thus, the keyboard embodiment used may be tailored to at least some of the applications. In some embodiments, one or more keyboard embodiments may be tailored to a respective user. For example, one or more keyboard embodiments may be tailored to a respective user based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

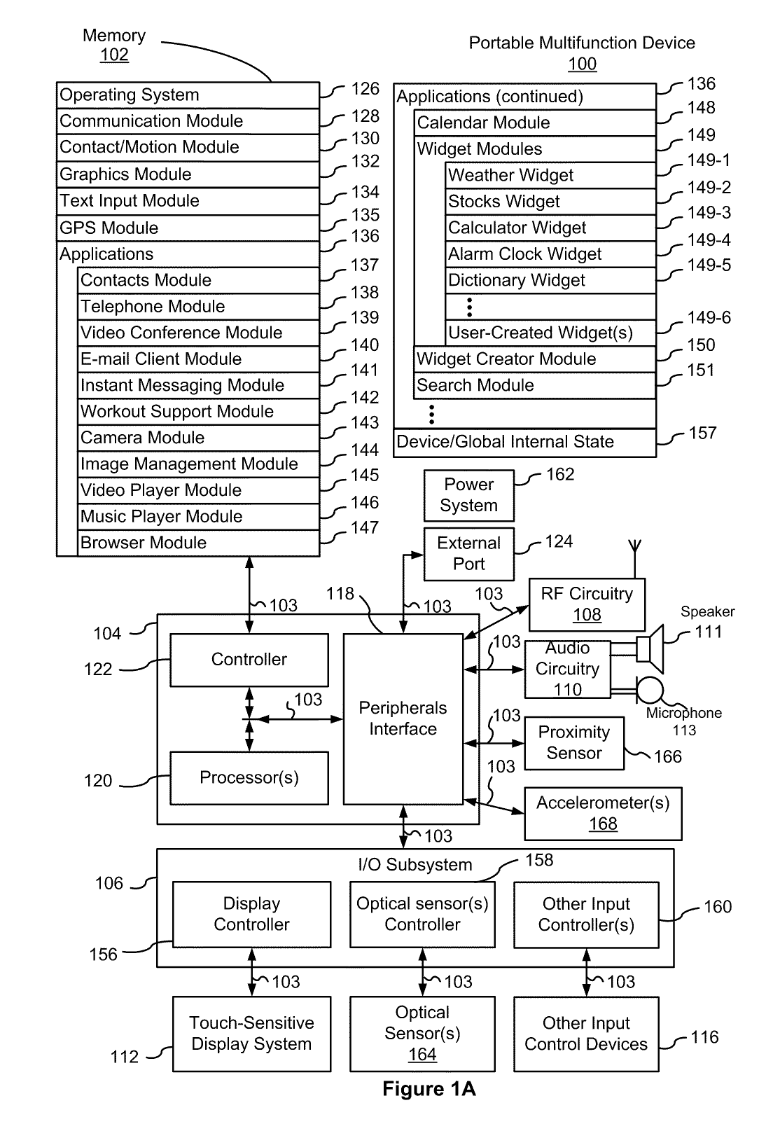

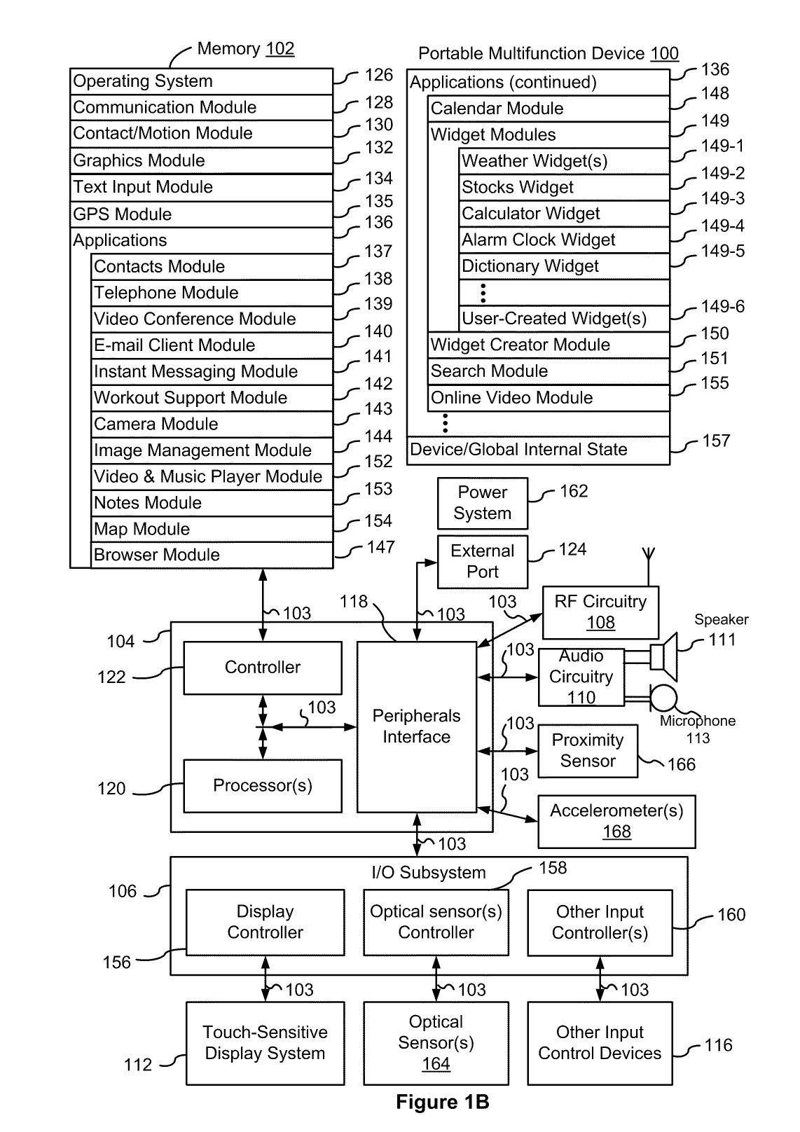

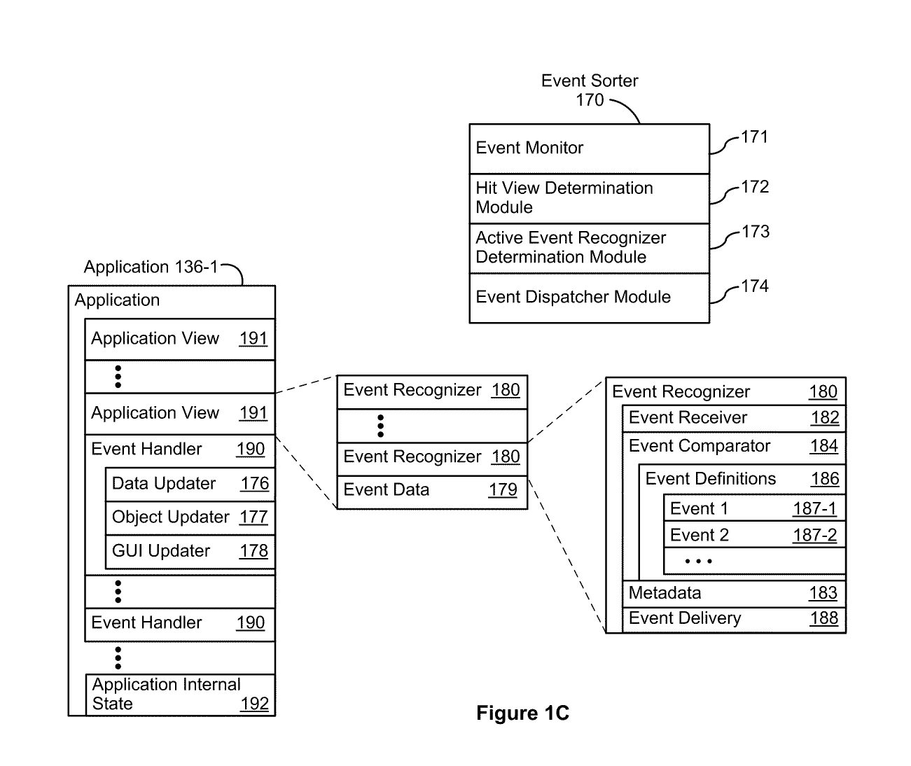

Attention is now directed toward embodiments of portable devices with touch-sensitive displays. FIGS. 1A and 1B are block diagrams illustrating portable multifunction devices 100 with touch-sensitive displays 112 in accordance with some embodiments. Touch-sensitive display 112 is sometimes called a “touch screen” for convenience, and may also be known as or called a touch-sensitive display system. Device 100 may include memory 102 (which may include one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 may include one or more optical sensors 164. These components may communicate over one or more communication buses or signal lines 103.

It should be appreciated that device 100 is only one example of a portable multifunction device, and that device 100 may have more or fewer components than shown, may combine two or more components, or may have a different configuration or arrangement of the components. The various components shown in FIGS. 1A and 1B may be implemented in hardware, software, or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of device 100, such as CPU 120 and the peripherals interface 118, may be controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 may be implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

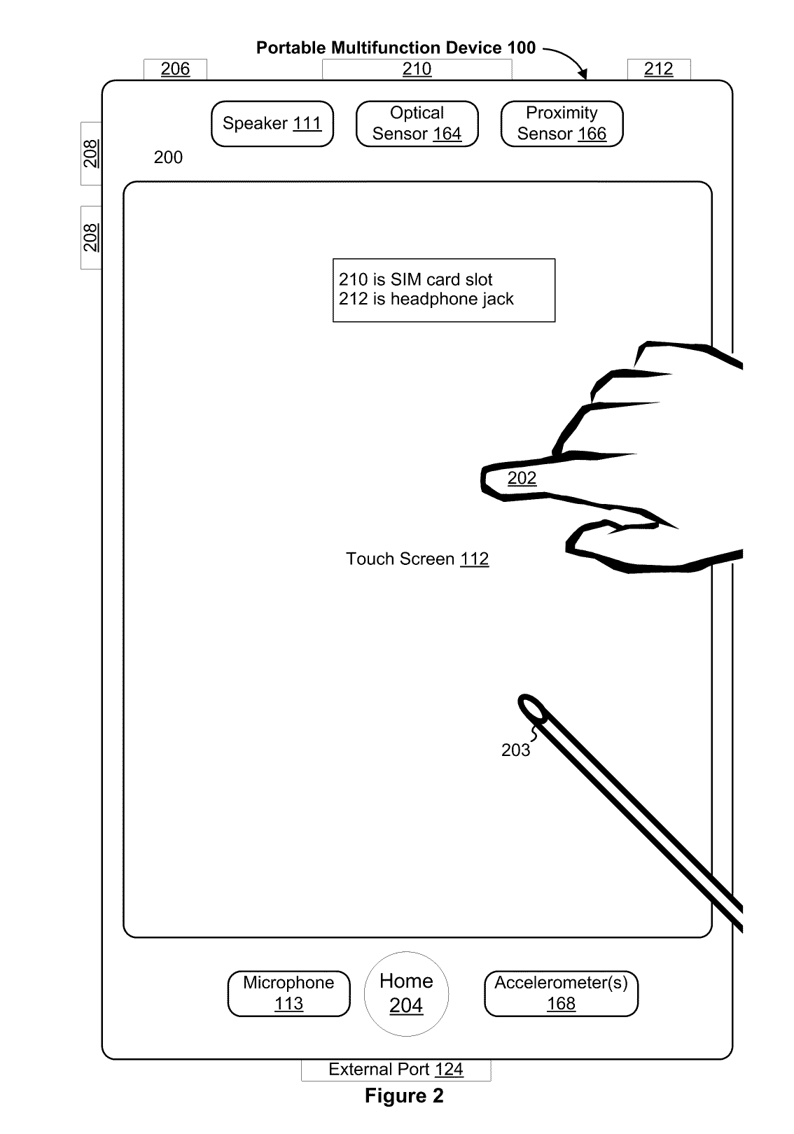

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 may include display controller 156 and one or more input controllers 160 for other input or control devices. The one or more input controllers 160 receive/send electrical signals from/to other input or control devices 116. The other input control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of speaker 111 and/or microphone 113. The one or more buttons may include a push button (e.g., 206, FIG. 2). A quick press of the push button may disengage a lock of touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button (e.g., 206) may turn power to device 100 on or off. The user may be able to customize a functionality of one or more of the buttons. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 may use LCD (liquid crystal display) technology, LPD (light emitting polymer display) technology, or LED (light emitting diode) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 may be analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from portable device 100, whereas touch sensitive touchpads do not provide visual output.

A touch-sensitive display in some embodiments of touch screen 112 may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 may have a video resolution in excess of 100 dpi. In some embodiments, the touch screen has a video resolution of approximately 132 dpi. The user may make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from touch screen 112 or an extension of the touch-sensitive surface formed by the touch screen.

In some embodiments, device 100 may include a physical or virtual wheel (e.g., a click wheel) as input control device 116. A user may navigate among and interact with one or more graphical objects (e.g., icons) displayed in touch screen 112 by rotating the click wheel or by moving a point of contact with the click wheel (e.g., where the amount of movement of the point of contact is measured by its angular displacement with respect to a center point of the click wheel). The click wheel may also be used to select one or more of the displayed icons. For example, the user may press down on at least a portion of the click wheel or an associated button. User commands and navigation commands provided by the user via the click wheel may be processed by input controller 160 as well as one or more of the modules and/or sets of instructions in memory 102. For a virtual click wheel, the click wheel and click wheel controller may be part of touch screen 112 and display controller 156, respectively. For a virtual click wheel, the click wheel may be either an opaque or semitransparent object that appears and disappears on the touch screen display in response to user interaction with the device. In some embodiments, a virtual click wheel is displayed on the touch screen of a portable multifunction device and operated by user contact with the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIGS. 1A and 1B show an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device, so that the touch screen display may be used as a viewfinder for still and/or video image acquisition. In some embodiments, an optical sensor is located on the front of the device so that the user's image may be obtained for videoconferencing while the user views the other video conference participants on the touch screen display. In some embodiments, the position of optical sensor 164 can be changed by the user (e.g., by rotating the lens and the sensor in the device housing) so that a single optical sensor 164 may be used along with the touch screen display for both video conferencing and still and/or video image acquisition.

Device 100 may also include one or more proximity sensors 166. FIGS. 1A and 1B show proximity sensor 166 coupled to peripherals interface 118. Alternately, proximity sensor 166 may be coupled to input controller 160 in I/O subsystem 106. Proximity sensor 166 may perform as described in U.S. patent application Ser. Nos. 11/241,839, “Proximity Detector In Handheld Device”; 11/240,788, “Proximity Detector In Handheld Device”; 11/620,702, “Using Ambient Light Sensor To Augment Proximity Sensor Output”; 11/586,862, “Automated Response To And Sensing Of User Activity In Portable Devices”; and 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 may also include one or more accelerometers 168. FIGS. 1A and 1B show accelerometer 168 coupled to peripherals interface 118. Alternately, accelerometer 168 may be coupled to an input controller 160 in I/O subsystem 106. Accelerometer 168 may perform as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

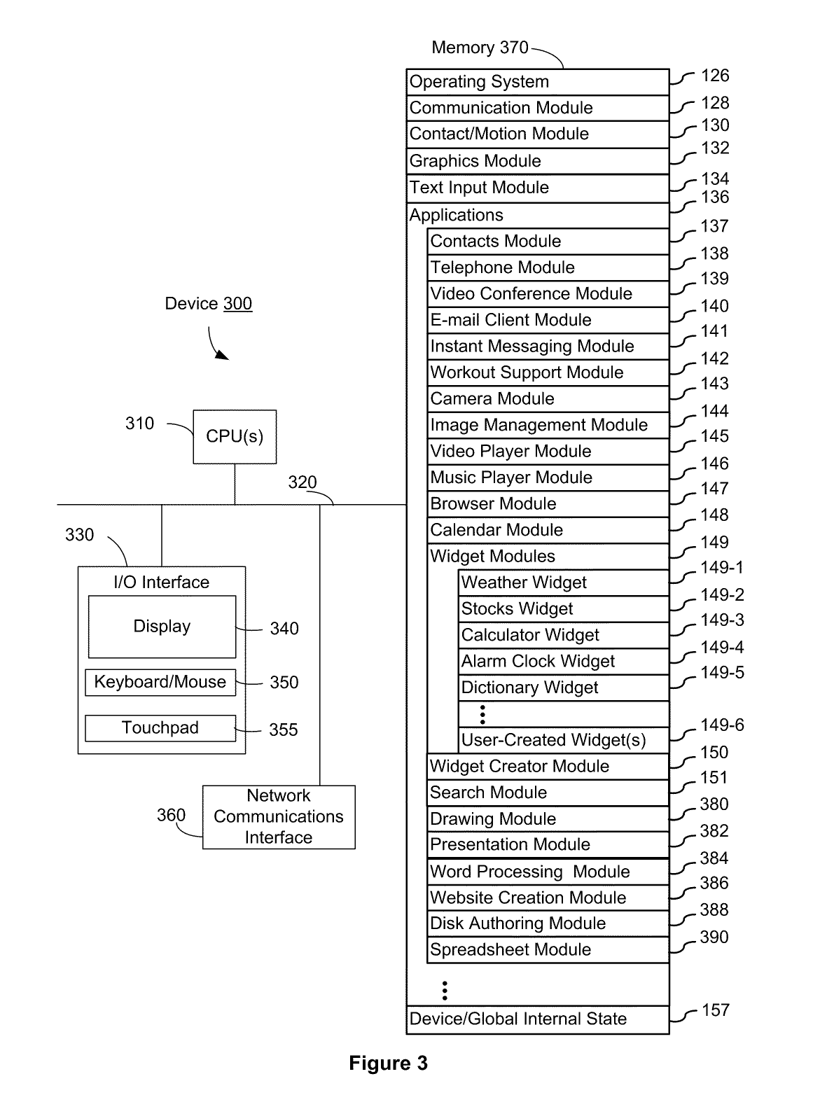

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in FIGS. 1A, 1B and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 may detect contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, contact/motion module 130 and display controller 156 detects contact on a touchpad. In some embodiments, contact/motion module 130 and controller 160 detects contact on a click wheel.

Contact/motion module 130 may detect a gesture input by a user. Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the intensity of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic may be assigned a corresponding code. Graphics module 132 receives, from applications etc., one or more codes specifying graphics to be displayed along with, if necessary, coordinate data and other graphic property data, and then generates screen image data to output to display controller 156.

Text input module 134, which may be a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 may include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module 145;
music player module 146;
browser module 147;
calendar module 148;
widget modules 149, which may include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module 145 and music player module 146;
notes module 153;
map module 154; and/or
online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, contacts module 137 may be used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 may be used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with touch screen 112, display controller 156, contact module 130, graphics module 132, audio circuitry 110, and speaker 111, video player module 145 includes executable instructions to display, present or otherwise play back videos (e.g., on touch screen 112 or on an external, connected display via external port 124).

In conjunction with touch screen 112, display system controller 156, contact module 130, graphics module 132, audio circuitry 110, speaker 111, RF circuitry 108, and browser module 147, music player module 146 includes executable instructions that allow the user to download and play back recorded music and other sound files stored in one or more file formats, such as MP3 or AAC files. In some embodiments, device 100 may include the functionality of an MP3 player, such as an iPod (trademark of Apple Inc.).

In conjunction with RF circuitry 108, touch screen 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact module 130, graphics module 132, and text input module 134, notes module 153 includes executable instructions to create and manage notes, to do lists, and the like in accordance with user instructions.

In conjunction with RF circuitry 108, touch screen 112, display system controller 156, contact module 130, graphics module 132, text input module 134, GPS module 135, and browser module 147, map module 154 may be used to receive, display, modify, and store maps and data associated with maps (e.g., driving directions; data on stores and other points of interest at or near a particular location; and other location-based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the content of which is hereby incorporated by reference in its entirety.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 1B). In some embodiments, memory 102 may store a subset of the modules and data structures identified above. Furthermore, memory 102 may store additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 may be reduced.

The predefined set of functions that may be performed exclusively through a touch screen and/or a touchpad include navigation between user interfaces. In some embodiments, the touchpad, when touched by the user, navigates device 100 to a main, home, or root menu from any user interface that may be displayed on device 100. In such embodiments, the touchpad may be referred to as a “menu button.” In some other embodiments, the menu button may be a physical push button or other physical input control device instead of a touchpad.

FIG. 1C is a block diagram illustrating exemplary components for event handling in accordance with some embodiments. In some embodiments, memory 102 (in FIGS. 1A and 1B) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is(are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 may utilize or call data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens, e.g., coordinating mouse movement and mouse button presses with or without single or multiple keyboard presses or holds, user movements taps, drags, scrolls, etc., on touch-pads, pen stylus inputs, movement of the device, oral instructions, detected eye movements, biometric inputs, and/or any combination thereof, which may be utilized as inputs corresponding to sub-events which define an event to be recognized.

FIG. 2 illustrates a portable multifunction device 100 having a touch screen 112 in accordance with some embodiments. The touch screen may display one or more graphics within user interface (UI) 200. In this embodiment, as well as others described below, a user may select one or more of the graphics by making contact or touching the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the contact may include a gesture, such as one or more taps, one or more swipes (from left to right, right to left, upward and/or downward) and/or a rolling of a finger (from right to left, left to right, upward and/or downward) that has made contact with device 100. In some embodiments, inadvertent contact with a graphic may not select the graphic. For example, a swipe gesture that sweeps over an application icon may not select the corresponding application when the gesture corresponding to selection is a tap.

Device 100 may also include one or more physical buttons, such as “home” or menu button 204. As described previously, menu button 204 may be used to navigate to any application 136 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also may accept verbal input for activation or deactivation of some functions through microphone 113.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 may include circuitry (sometimes called a chipset) that interconnects and controls communications between system components. Device 300 includes input/output (I/O) interface 330 comprising display 340, which is typically a touch screen display. I/O interface 330 also may include a keyboard and/or mouse (or other pointing device) 350 and touchpad 355. Memory 370 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 370 may optionally include one or more storage devices remotely located from CPU(s) 310. In some embodiments, memory 370 stores programs, modules, and data structures analogous to the programs, modules, and data structures stored in memory 102 of portable multifunction device 100 (FIG. 1), or a subset thereof. Furthermore, memory 370 may store additional programs, modules, and data structures not present in memory 102 of portable multifunction device 100. For example, memory 370 of device 300 may store drawing module 380, presentation module 382, word processing module 384, website creation module 386, disk authoring module 388, and/or spreadsheet module 390, while memory 102 of portable multifunction device 100 (FIG. 1) may not store these modules.

Each of the above identified elements in FIG. 3 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 370 may store a subset of the modules and data structures identified above. Furthermore, memory 370 may store additional modules and data structures not described above.

Attention is now directed towards embodiments of user interfaces (“UI”) that may be implemented on portable multifunction device 100.

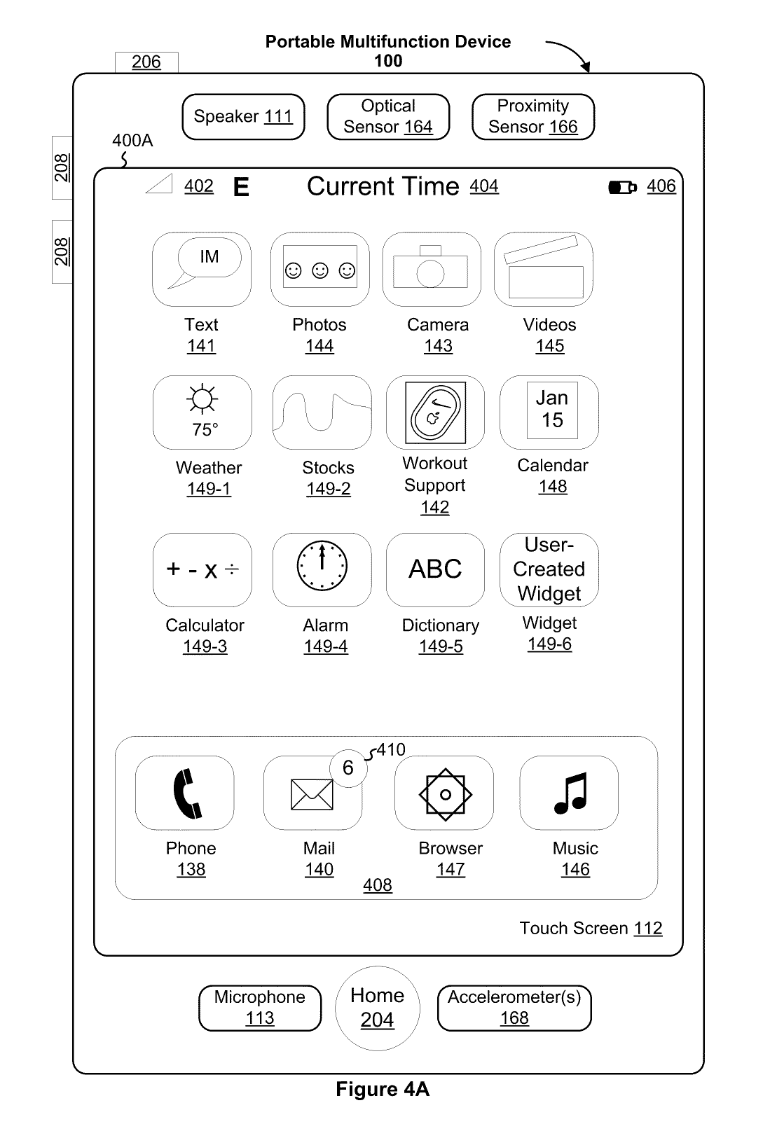

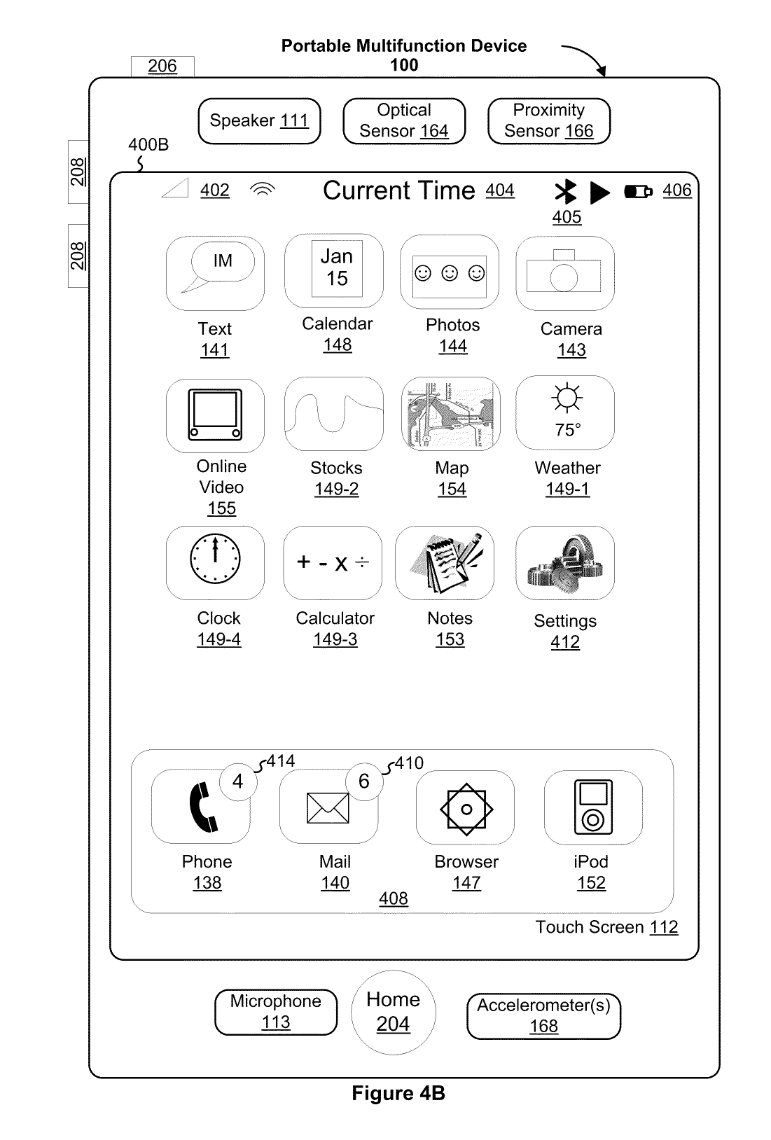

FIGS. 4A and 4B illustrate exemplary user interfaces for a menu of applications on portable multifunction device 100 in accordance with some embodiments. Similar user interfaces may be implemented on device 300. In some embodiments, user interface 400A includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Phone 138, which may include an indicator 414 of the number of missed calls or voicemail messages;
   E-mail client 140, which may include an indicator 410 of the number of unread e-mails;
   Browser 147; and
   Music player 146; and
Icons for other applications, such as:
   IM 141;
   Image management 144;
   Camera 143;
   Video player 145;
   Weather 149-1;
   Stocks 149-2;
   Workout support 142;
   Calendar 148;
   Calculator 149-3;
   Alarm clock 149-4;
   Dictionary 149-5; and
   User-created widget 149-6.

In some embodiments, user interface 400B includes the following elements, or a subset or superset thereof:
402, 404, 405, 406, 141, 148, 144, 143, 149-3, 149-2, 149-1, 149-4, 410, 414, 138, 140, and 147, as described above;
Map 154;
Notes 153;
Settings 412, which provides access to settings for device 100 and its various applications 136, as described further below;
Video and music player module 152, also referred to as iPod (trademark of Apple Inc.) module 152; and
Online video module 155, also referred to as YouTube (trademark of Google Inc.) module 155.

Attention is now directed towards embodiments of user interfaces (“UI”) and associated processes that may be implemented on a multifunction device with a display and a touch-sensitive surface, such as device 300 or portable multifunction device 100.

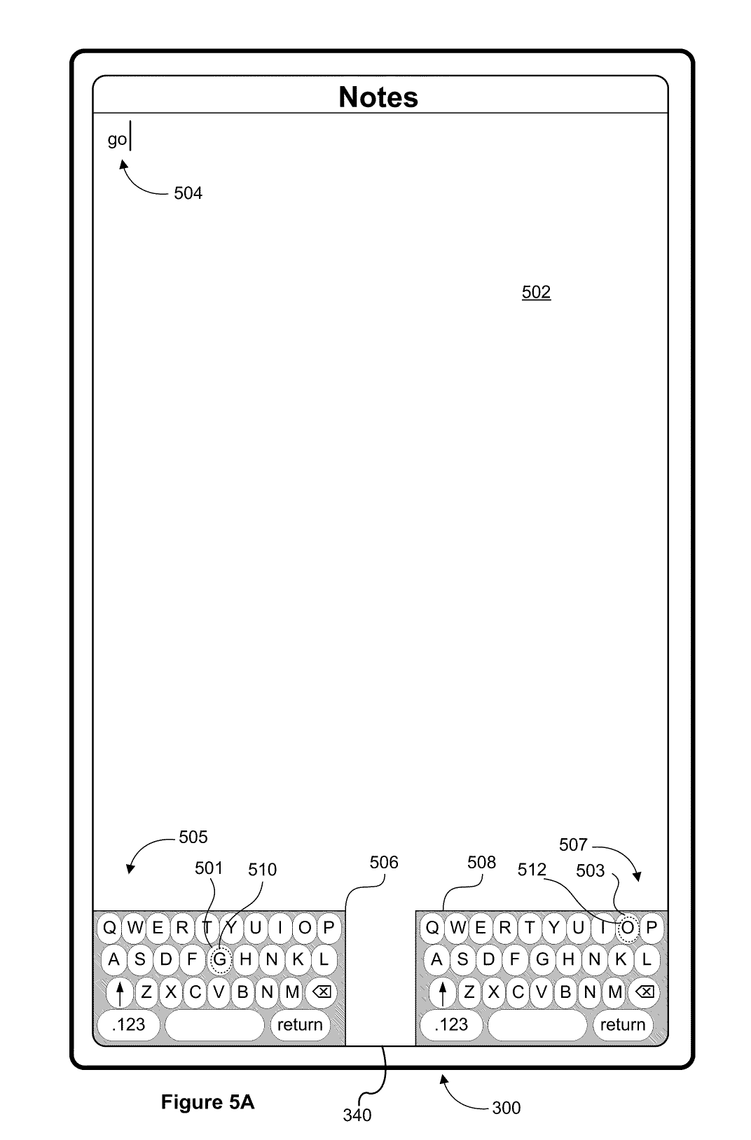

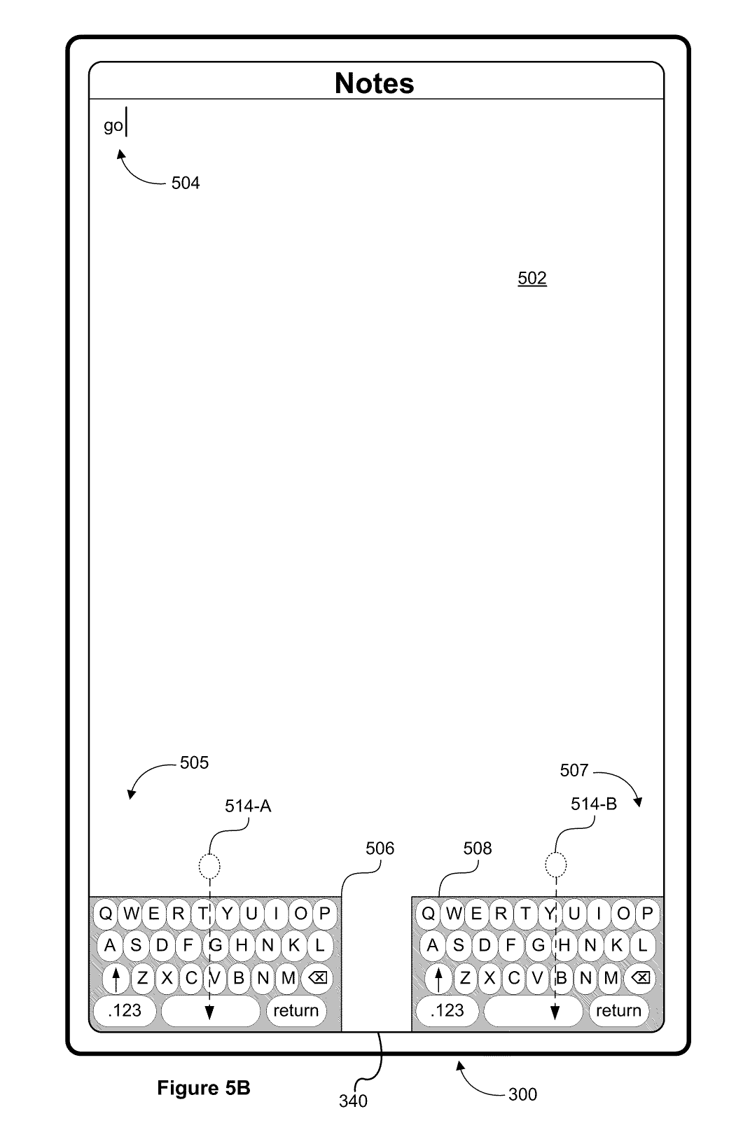

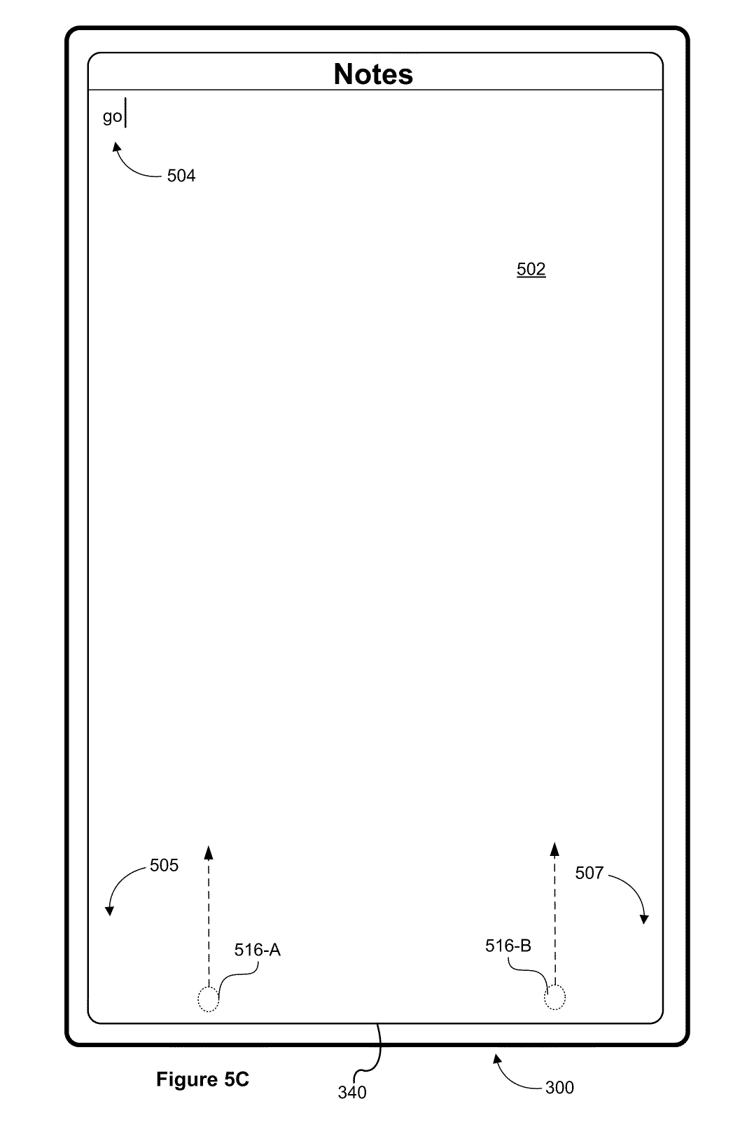

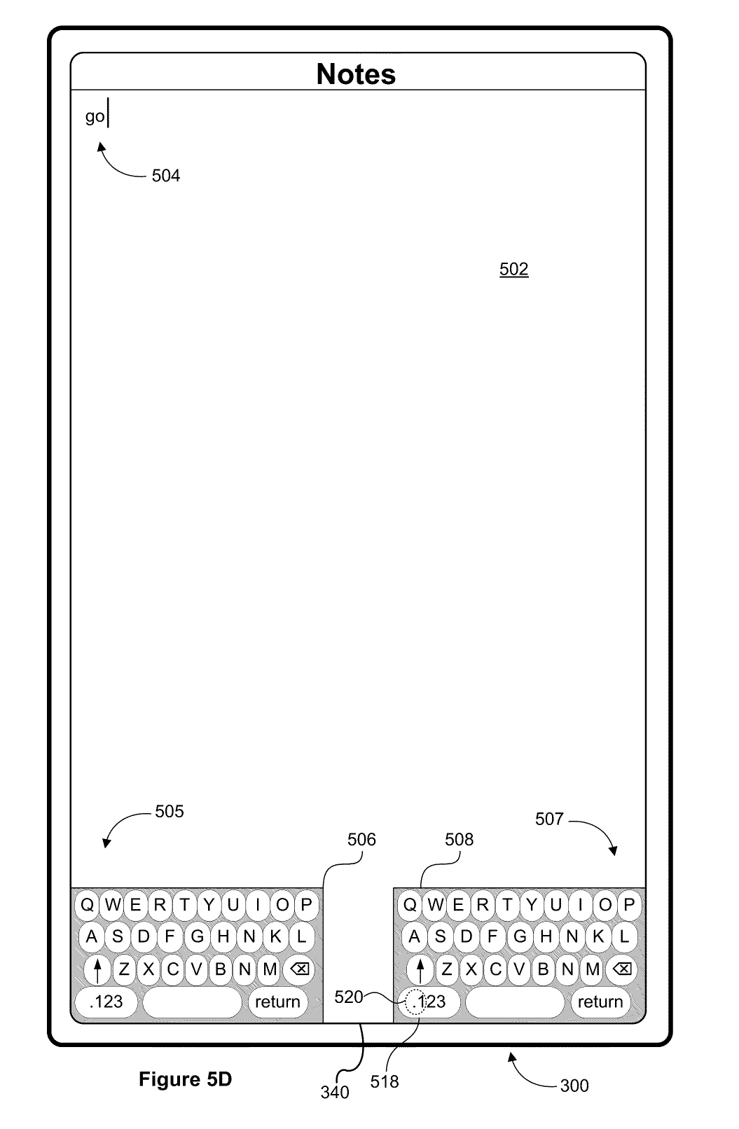

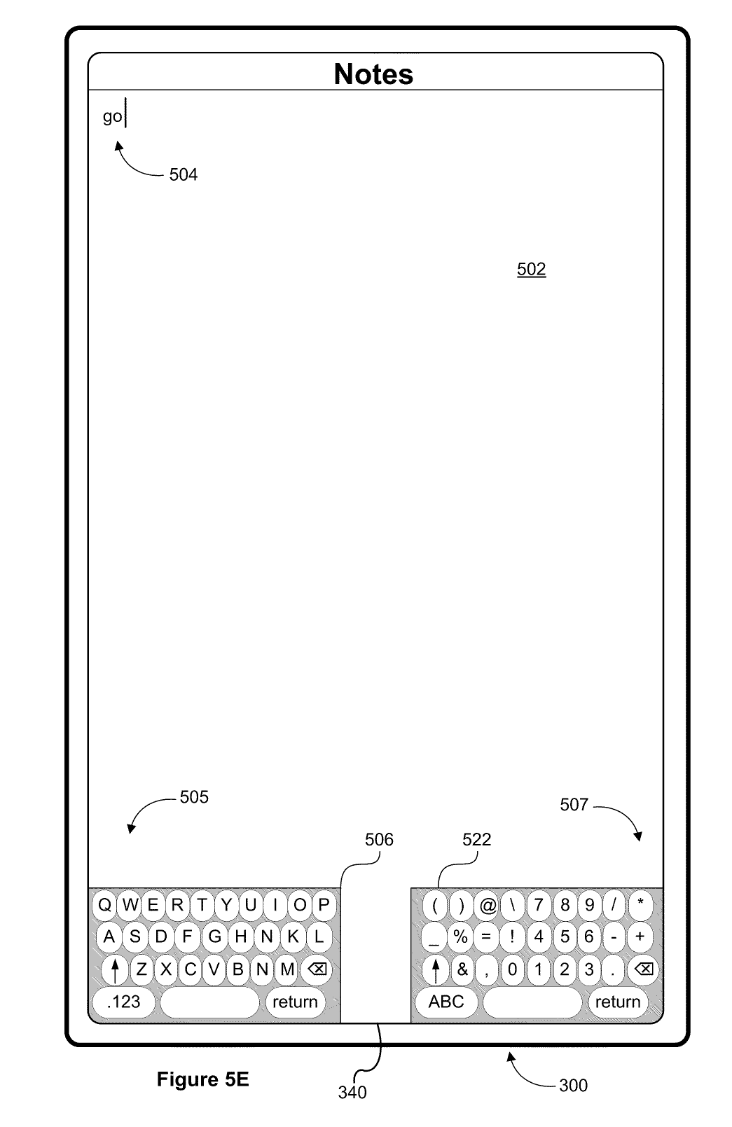

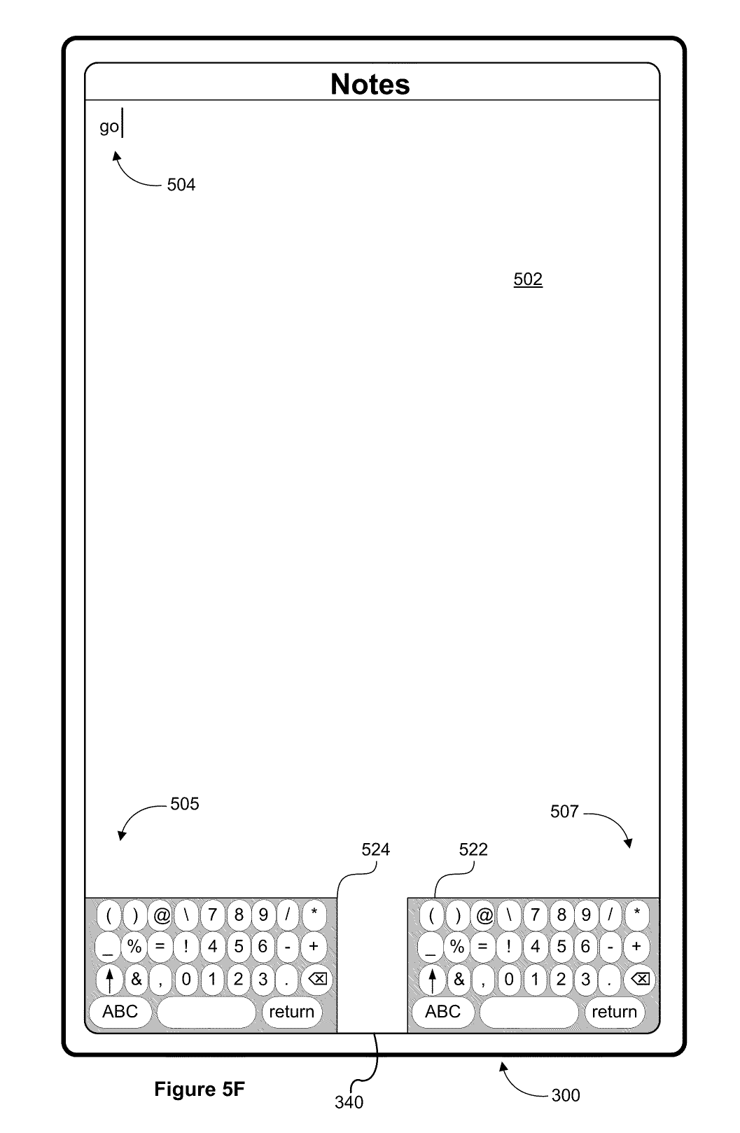

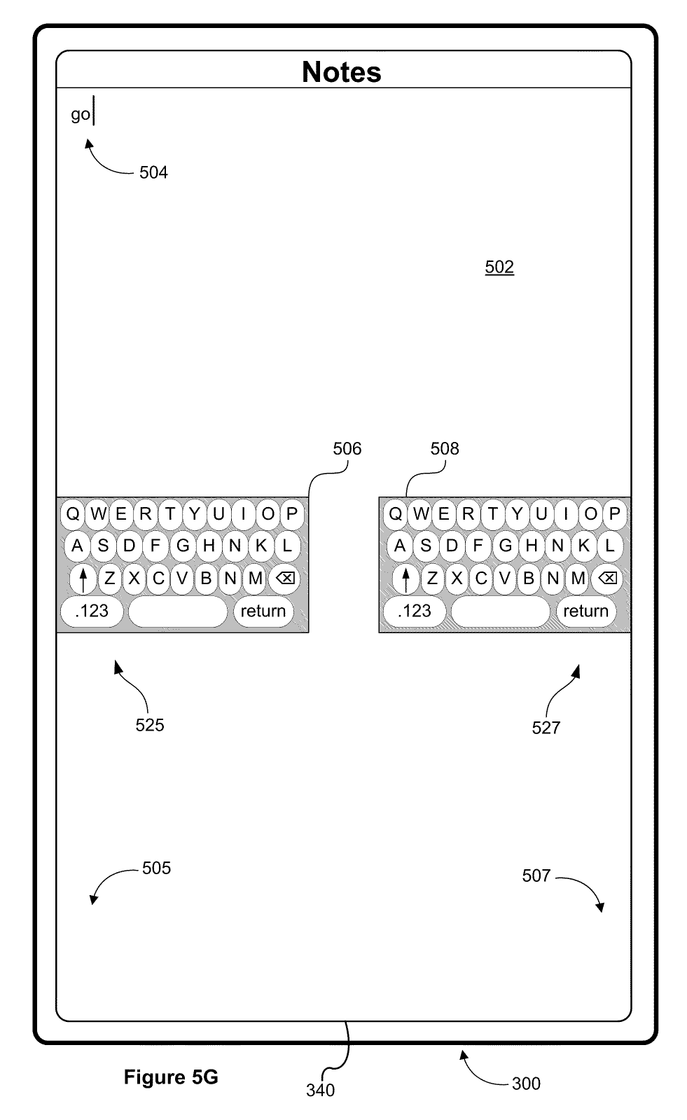

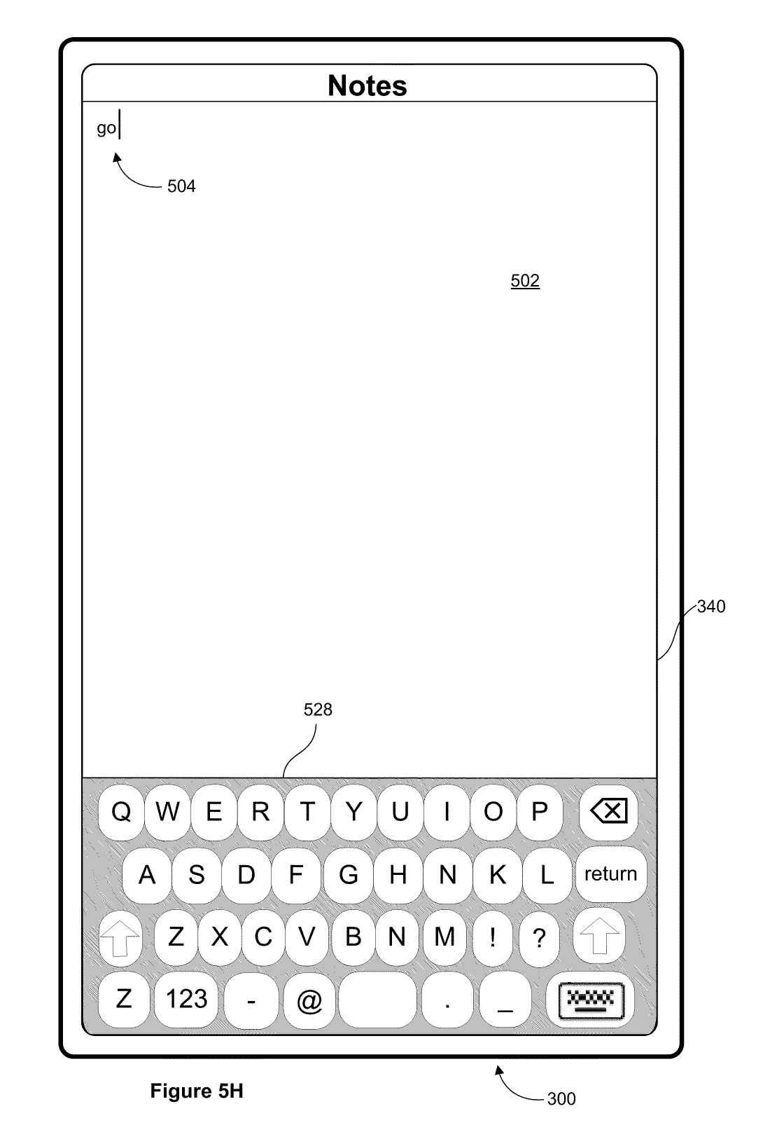

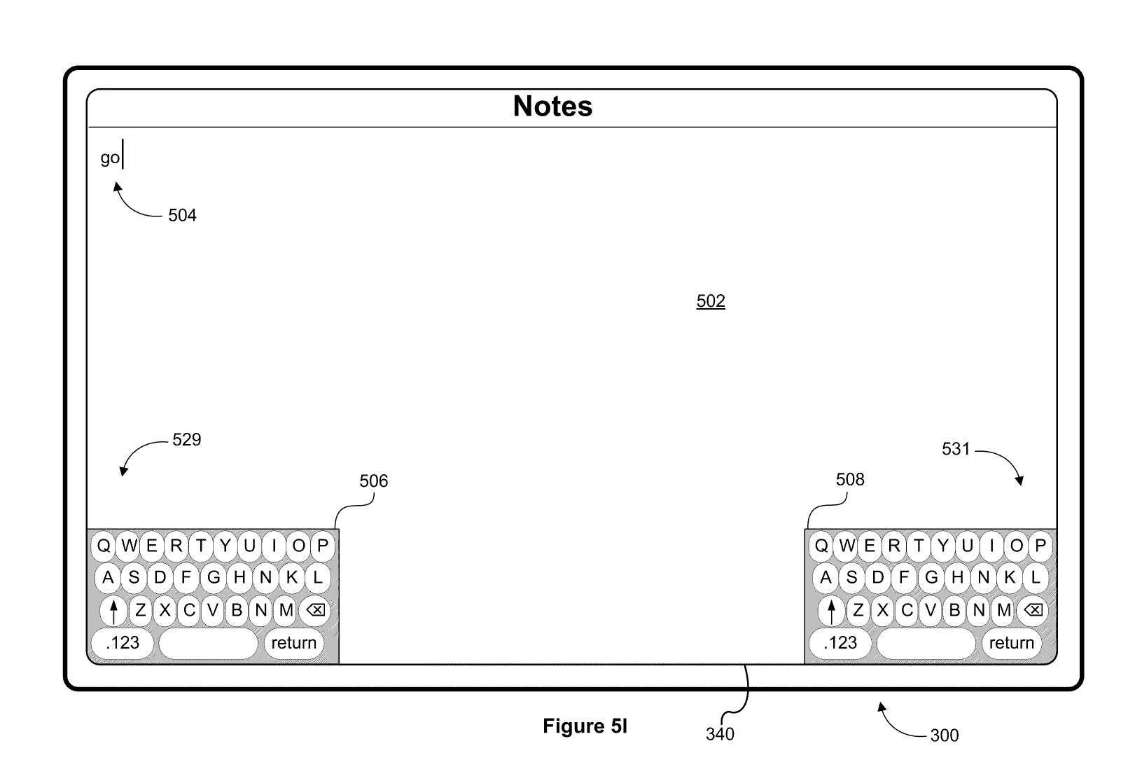

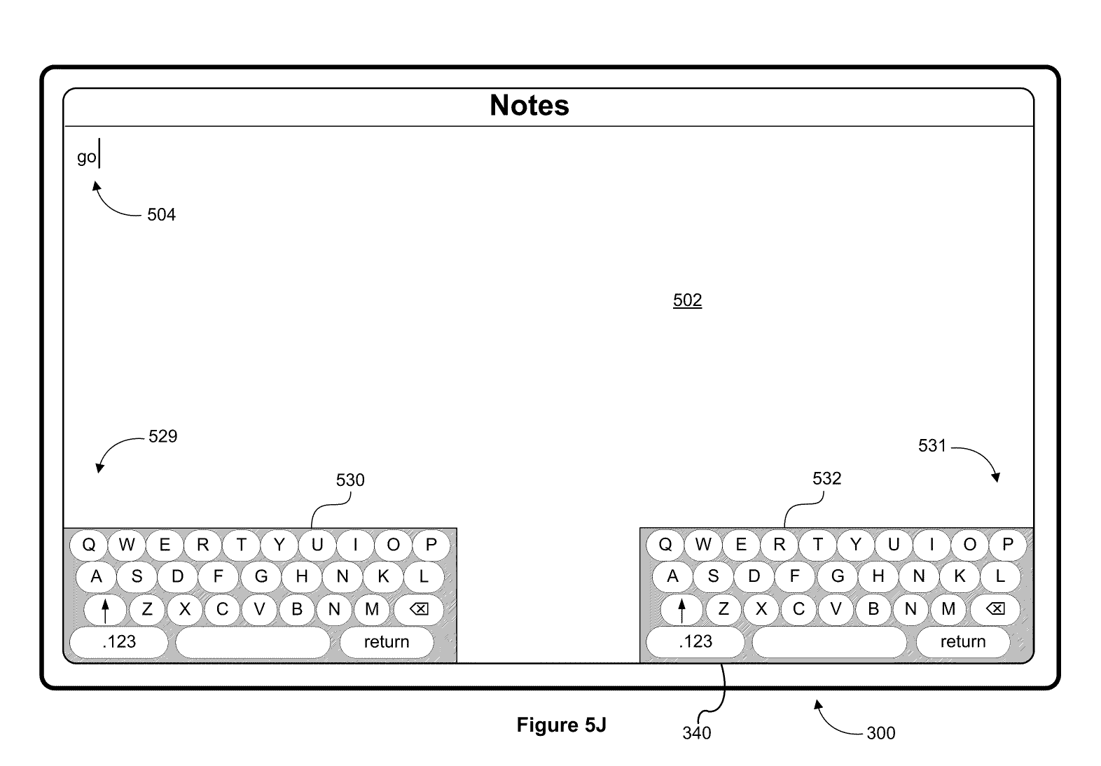

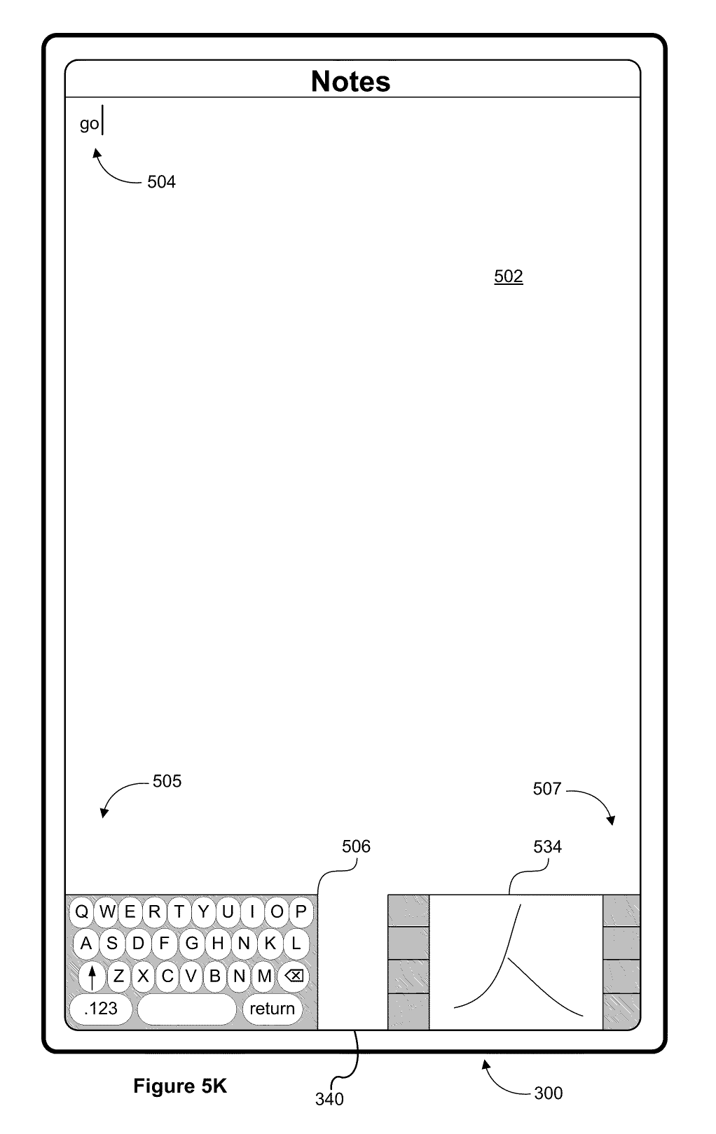

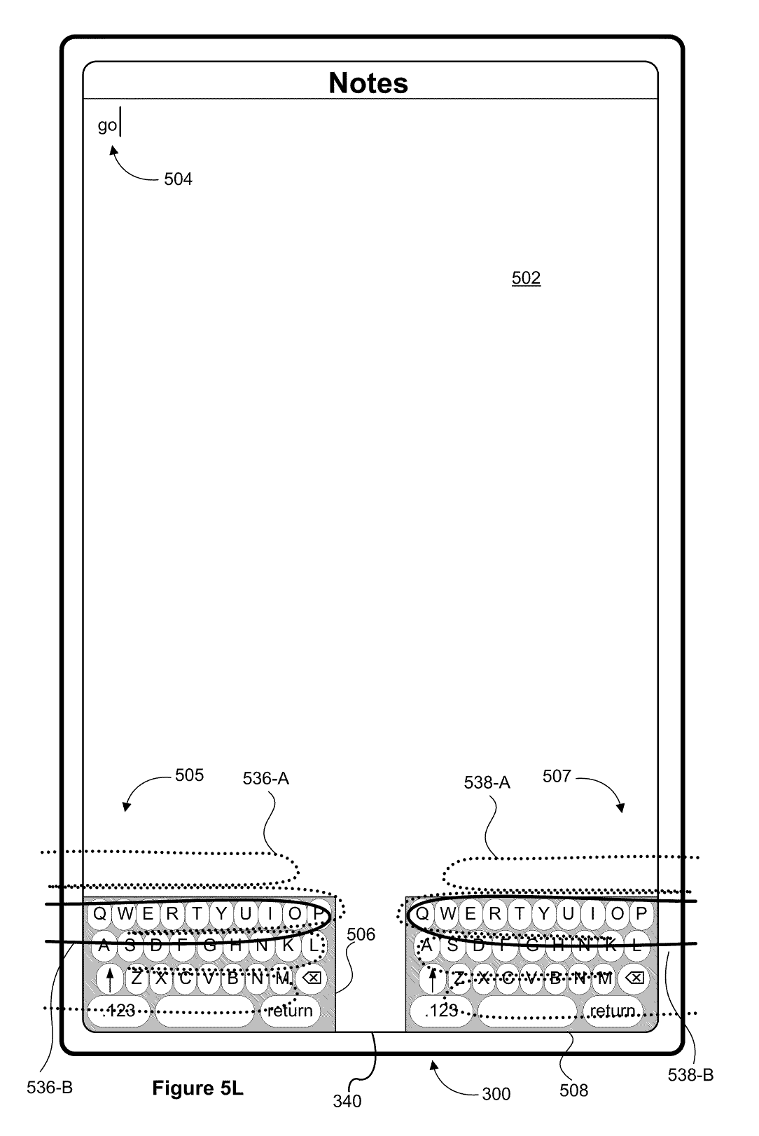

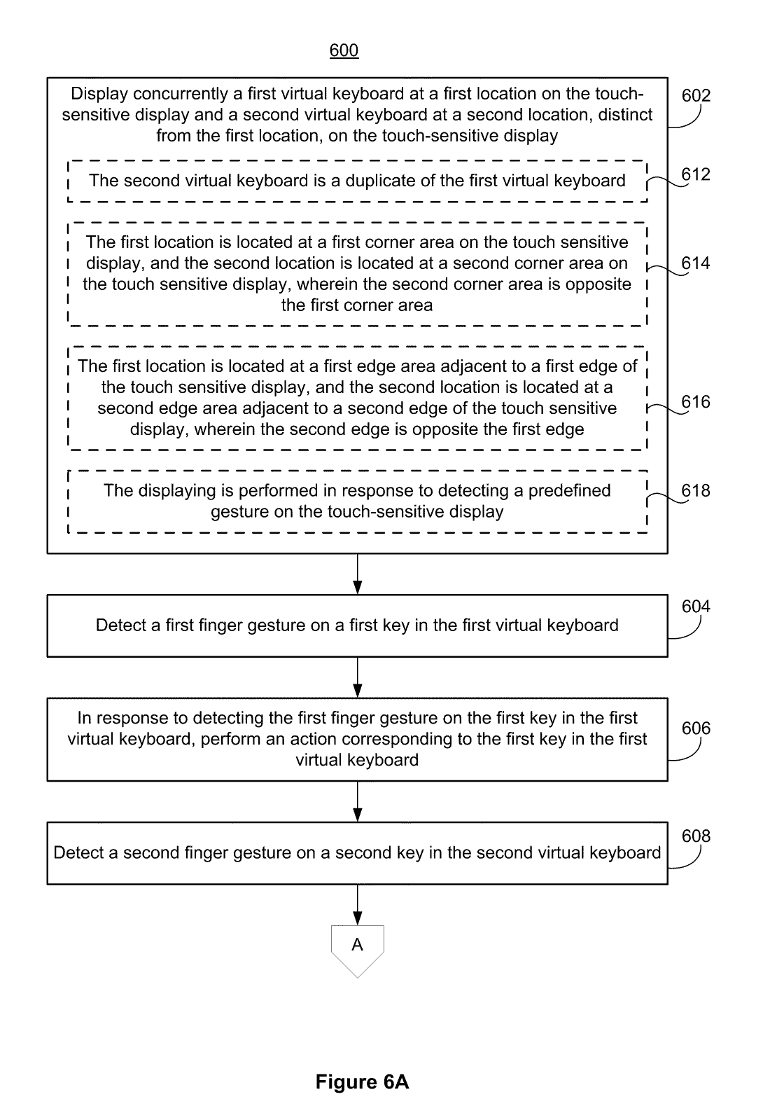

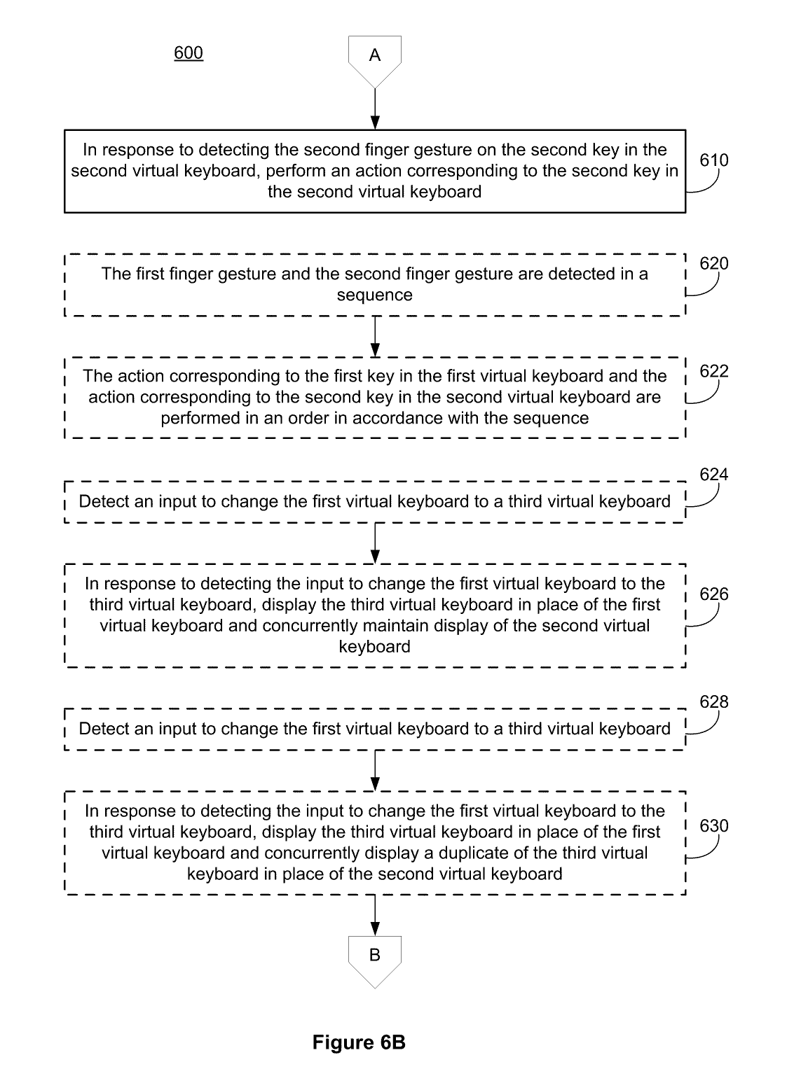

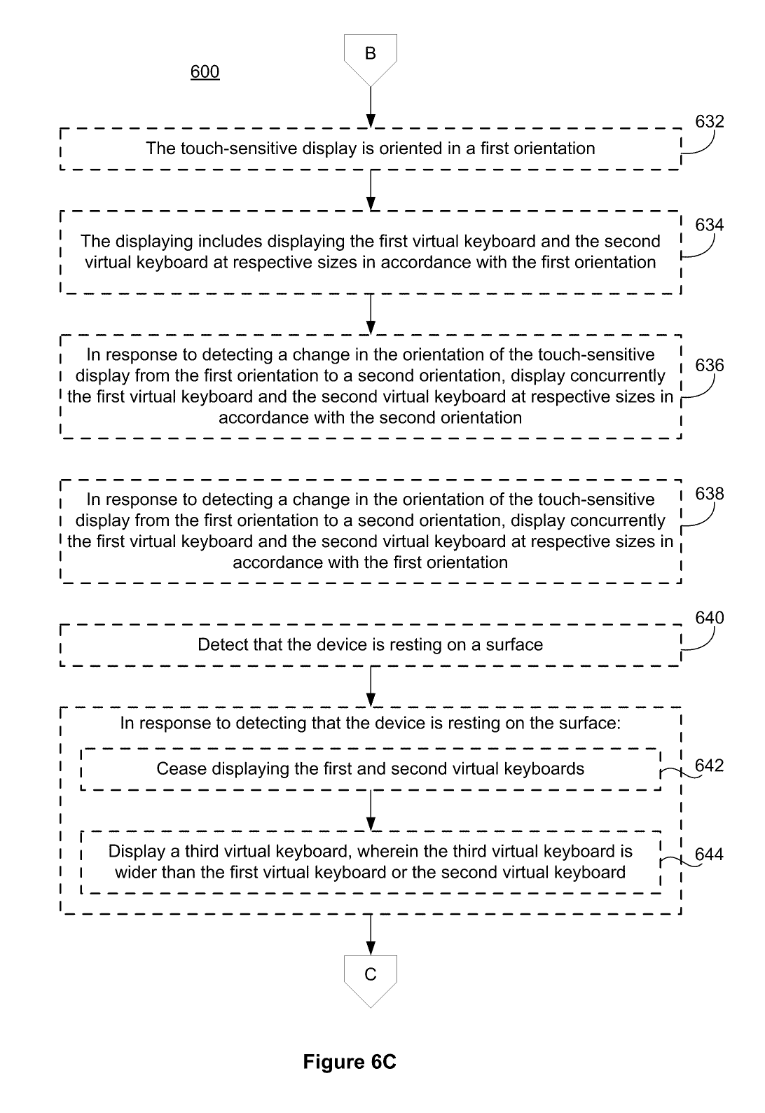

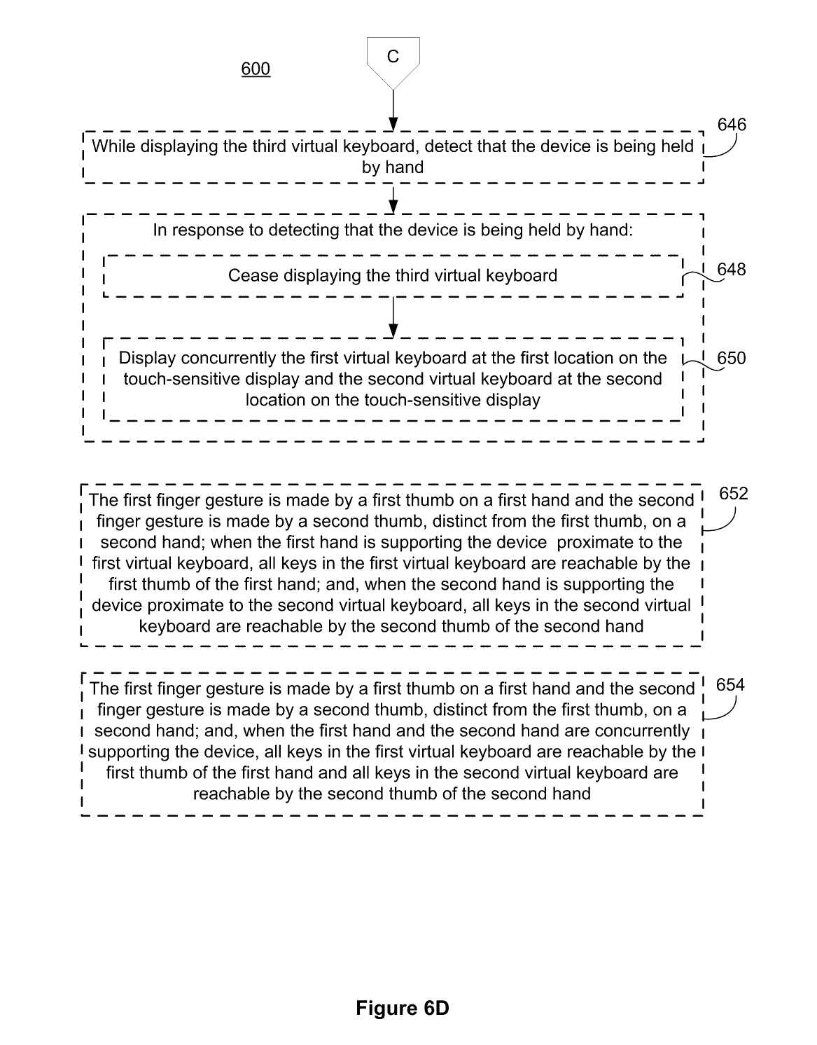

FIGS. 5A-5L illustrate exemplary user interfaces for concurrent virtual keyboards in accordance with some embodiments. The user interfaces in these figures are used to illustrate the processes described below, including the processes in FIGS. 6A-6D.

FIG. 5A depicts a user interface displayed on touch-sensitive display 340 of device 300. In FIGS. 5A-5L, device 300 has a relatively large form factor compared to, for example, a smaller form factor device, such as a mobile phone. In some embodiments, device 300 is a tablet computer.

The user interface displayed on touch-sensitive display 340 includes application content area 502 (e.g., a notes application). Application content area 502 may include one or more fields or areas for text input. Input text 504 may be displayed in application content area 502 (e.g., in a text input area or field). Virtual keyboards 506 and 508 are displayed concurrently on display 340. Keyboards 506, 508 are each displayed at a respective location on display 340 such that keyboards 506 and 508 do not overlap each other; keyboards 506 and 508 are each displayed at distinct locations on display 340. In some embodiments, the locations where keyboards 506, 508 are displayed are opposite corner areas. For example, in FIG. 5A, keyboard 506 is displayed at corner area 505 at the lower left corner of display 340, and keyboard 508 is displayed at corner area 507, horizontally opposite of corner area 505, at the lower right corner of display 340.

In FIG. 5A, the keyboard displayed at area 505 (keyboard 506) and the keyboard displayed at area 507 (keyboard 508) are the same; keyboard 508 is a duplicate of keyboard 506. Keyboard 508 is the same size as keyboard 506, and has the same set of keys and the same functionality as keyboard 506. In some embodiments, the keyboard displayed at area 505 may be different from the keyboard displayed at area 507. For example, a QWERTY English keyboard may be displayed at area 507 and a Cyrillic keyboard may be displayed at area 505.

Each of keyboards 506 and 508 are “full” keyboards, as opposed to partial keyboards. For example, keyboard 506 includes the entire English alphabet arranged in a QWERTY layout, as opposed to merely a portion of the English alphabet (e.g., the left half of the QWERTY layout). Keyboard 508 also includes the entire English alphabet arranged in a QWERTY layout, as opposed to merely the other portion of the English alphabet (e.g., the complementary right half of the QWERTY layout). Thus, a user may input text using either keyboard 506 or 508 without using the other keyboard. The user may also input text using both keyboards. For example, in FIG. 5A, gestures (e.g., tap gestures) 510 and 512 are detected on keyboards 506 and 508, respectively. Gesture 510 is detected on “G” key 501 in keyboard 506, and gesture 512 is detected on “O” key 503 in keyboard 508. If gesture 510 is detected by device 300 before gesture 512, then “G” key 501 is activated first and then “O” key 503 is activated. The resulting output is input text “go,” as shown in input text 504 in FIG. 5A. On the other hand, if gesture 512 is detected by device 300 before gesture 510, then “O” key 503 is activated first and then “G” key 501 is activated. The resulting output is input text “og.”

In some embodiments, when a key on keyboard 506 or 508 is activated, visual feedback is displayed on display 300 in the proximity of the keyboard where the corresponding key activation gesture was detected. For example, if a key in keyboard 506 is held for at least a predefined period of time, a popup for selecting alternate characters may be displayed near or over keyboard 506 (where the gesture was detected). In some embodiments, the same visual feedback is displayed near or over each respective keyboard. In some embodiments, the visual feedback is displayed centered above the two keyboards.

By displaying keyboards 506 and 508 at corner areas 505 and 507, respectively, device 300 facilitates more efficient thumb-typing by users who have developed muscle memory from thumb-typing on small form-factor devices (e.g., a smart phone). Keyboards 506 and 508, which are displayed at the corners and at a size as if they are displayed on a small form factor device, allow a user who holds device 300 by hand to adapt more easily to thumb-typing on device 300 by taking advantage of the developed muscle memory. As a result, thumb-typing on device 300 is performed more efficiently.

Keyboards 506 and 508 may be hidden in response to detection of a predefined gesture. In FIG. 5B, two-finger gesture 514 is detected, with finger contact 514-A detected in proximity of keyboard 506 and finger contact 514-B detected in proximity of keyboard 508. Downward movement of contacts 514-A and 514-B is detected, completing the gesture. In response to detecting gesture 514, keyboards 506 and 508 cease to be displayed, as shown in FIG. 5C.

Keyboards 506 and 508 may be displayed in response to detection of a predefined gesture. In FIG. 5C, while no keyboard is displayed at locations 505 and 507, two-finger gesture 516 is detected, with finger contact 516-A detected in area 505 and finger contact 516-B detected in area 507. Upward movement of contacts 516-A and 516-B is detected, completing the gesture. In response to detecting gesture 516, keyboards 506 and 508 are concurrently displayed, as shown in FIG. 5D. The keyboards displayed at locations 505 and 507 may be changed, together or independently of each other, to other virtual keyboards (e.g., number and symbols keyboards, or keyboards for different languages). FIG. 5D depicts detection of an input to change keyboard 508. Gesture (e.g., a tap gesture) 520 is detected on key 518 in keyboard 508. Key 518 in keyboard 508 is a key to change keyboard 508 to a number and symbols keyboard. In some embodiments, in response to detecting gesture 520, keyboard 508 changes to number/symbols keyboard 522 and keyboard 506 remains as is, as shown in FIG. 5E. In some other embodiments, in response to detecting gesture 520, keyboard 508 changes to number/symbols keyboard 522 and keyboard 506 changes to number/symbols keyboard 524, which is a duplicate of keyboard 522, as shown in FIG. 5F. Whether just one keyboard changes or both keyboards change may be a setting on device 300 that a user can select.

In some embodiments, keyboard 506 and/or 508 may be changed to a handwriting recognition field (e.g., handwriting recognition field 534, FIG. 5K).

While the embodiments described above describe keyboards 506 and 508 as displayed at corner areas 505 and 507, respectively, in some embodiments keyboards 506 and 508 are displayed at locations other than corner areas 505 and 507. FIG. 5G depicts keyboards 506 and 508 displayed at areas adjacent to opposite edges of display 340 and away from corner areas 505 and 507. Keyboard 506 is displayed at area 525, which is adjacent to the left edge of display 340 and approximately halfway between the upper edge and the lower edge of display 340. Keyboard 508 is displayed at area 527, which is adjacent to the right edge of display 340 and opposite area 525. Having keyboards 506 and 508 at areas 525 and 527, respectively, facilitates more efficient thumb-typing by users who have developed muscle memory for thumb-typing on small form-factor devices (e.g., a smart phone). A user that is holding device 300 in proximity of areas 525 and 527 by hand may thumb-type using keyboards 506 and 508 displayed at areas 525 and 527, respectively, with little or no muscle re-training. As a result, the user types on device 300 more efficiently.

Like the keyboards depicted in FIGS. 5D-5F, the virtual keyboards displayed at locations 525 and 527 may be changed to other virtual keyboards together or independently of each other.

In some embodiments, device 300 displays keyboards 5060 and 508 on display 340 at locations that correspond to (or are proximate to) the locations on the back side of the device of the hands holding the device. For example, device 300 displays keyboards 506 and 508 at corner areas (e.g., areas 505 and 507) or edge areas (e.g., areas 525, 527) based on whether device 300 is being held by hand at the lower end of device 300 or at approximately the middle of device 300. In some embodiments, one or more sensors in device 300 (e.g., an accelerometer, gyro, or touch-sensitive surface on the device casing) detects whether the device is being held at the lower end or at the middle and, in response, device 300 displays keyboards 506, 508 at locations that are proximate to the locations of the hand grips (e.g., corner areas 505 and 507 if the hand grips are at the lower end of device 300, and areas 525 and 527 if the hand grips are at approximately the middle of device 300).

In some embodiments, device 300 displays a full-width keyboard instead of two smaller keyboards (e.g., keyboards 506 and 508) when device 300 is resting on a surface (e.g., a tabletop) instead of being held by hand. For example, in FIG. 5H, virtual keyboard 528 spans the width of display 340. In some embodiments, device 300 displays keyboards 506 and 508 at the corner areas (areas 505 and 507) or keyboard 528 instead of keyboards 506, 508 based on whether device 300 is being held by hands or resting on a surface (e.g., a tabletop). In some embodiments, one or more sensors in device 300 (e.g., an accelerometer or touch-sensitive surface on the device casing) detects whether device 300 is resting on a surface or being held by hand and, in response, device 300 displays keyboards 506, 508 if device 300 is being held by hand or displays keyboard 528 if device 300 is resting on a surface.

Keyboards 506 and 508 may be displayed at different sizes depending on the orientation of device 300. For example, in FIG. 5A, device 300 is in portrait orientation. Keyboards 506 and 508 are displayed at respective sizes in accordance with the portrait orientation; each of keyboards 506 and 508 is sized as if it is displayed on a small form factor device in portrait orientation. FIG. 5I depicts device 300 in landscape orientation. Device 300 goes from portrait orientation to landscape orientation (or vice versa) when a user rotates device 300 90 degrees on an axis perpendicular to display 340. With the change in orientation, keyboards 506 and 508 are displayed at corner areas 529 and 531, respectively, and rotated along with device 300 to maintain an upright orientation. In FIG. 5I, each of keyboards 506 and 508 are displayed at the same size as when device 300 is in portrait orientation (as in FIG. 5A). In some embodiments, when device 300 goes from portrait to landscape orientation, each of keyboards 506 and 508 are resized such that each of the keyboards are sized as if the keyboard is displayed on a small form factor device in landscape orientation. For example, in FIG. 5J, keyboards 530 and 532 are displayed at corner areas 529 and 531, respectively. Keyboards 530 and 532 are wider than keyboards 506 and 508, respectively. Each of keyboards 530 and 532 is sized as if it is displayed on a small form factor device in landscape orientation.

The keyboards displayed at locations 529 and 531 may be, analogous to the examples depicted in FIGS. 5D-5F, changed to other keyboards together or independently of each other.

FIG. 5L depicts an example of device 300 being held by hand, with the hands positioned for thumb typing. Left hand 536 is supporting device 300 (e.g., with dashed fingers 536-A supporting the backside of device 300) and is positioned proximate to keyboard 506. Right hand 538 is supporting device 300 (e.g., with dashed fingers 538-A supporting the backside of device 300) and is positioned proximate to keyboard 508. In FIG. 5L, the non-thumb fingers are drawn with dashed lines to indicate that they are contacting the back surface of the device, while the thumbs are drawn with solid lines to indicate that they are contacting the front surface of the device. Left thumb 536-B of left hand 536 can reach the “P” key in keyboard 506, which is the key in keyboard 506 furthest from the left-side edge of device 300, as well as any of the other keys in keyboard 506. Similarly, right thumb 538-B of right hand 538 can reach the “Q” key in keyboard 508, which is the key in keyboard 508 furthest from the right-side edge of device 300, as well as any of the other keys in keyboard 508. Thus, while left hand 536 is supporting device 300, left thumb 536-B can contemporaneously activate any of the keys in left-side keyboard 506. While right hand 538 is supporting device 300, right thumb 538-B can contemporaneously activate any of the keys in right-side keyboard 508. By displaying virtual keyboards 506 and 508 at a small form factor size, thus enabling all of the keys in a respective virtual keyboard to be reachable by a thumb of a hand positioned in proximity to the respective virtual keyboard, thumb-typing on a large form factor device (e.g., a tablet) using one or both thumbs is facilitated.

It should be appreciated that while the example depicted in FIG. 5L shows virtual keyboards 506 and 508 displayed at corner areas 505 and 507, respectively, and hands 536 and 538 are positioned in proximity to corner areas 505 and 507, the example depicted in FIG. 5L applies analogously when virtual keyboards are displayed away from corner areas (e.g., as in FIG. 5G), and the hands are positioned in proximity to where the virtual keyboards are displayed.

FIGS. 6A-6D are flow diagrams illustrating a method 600 of activating keys in concurrent virtual keyboards in accordance with some embodiments. The method 600 is performed at a multifunction device (e.g., device 300, FIG. 3, or portable multifunction device 100, FIG. 1) with a touch screen display. Some operations in method 600 may be combined and/or the order of some operations may be changed.

As described below, the method 600 provides an intuitive way to activate keys using concurrent virtual keyboards. The method reduces the physical and cognitive burdens on a user when activating keys in virtual keyboards, thereby creating a more efficient human-machine interface. The method facilitates more efficient thumb-typing by users who have developed muscle memory from thumb-typing on small form-factor devices (e.g., smart phones). For battery-operated computing devices, enabling a user to use virtual keyboards faster and more efficiently conserves power and increases the time between battery charges.

The device displays (602) concurrently a first virtual keyboard at a first location on the touch-sensitive display and a second virtual keyboard at a second location, distinct from the first location, on the touch-sensitive display. For example, in FIG. 5A, virtual keyboard 506 is displayed at area 505 and virtual keyboard 508 is displayed at area 507.

In some embodiments, the first and second virtual keyboards are each full keyboards, as opposed to one being a half or split keyboard and the other one being the complementary half or split keyboard. For example, each of keyboards 506 and 508 is a QWERTY keyboard with the entire alphabet on the keyboard.

In some embodiments, the first and second virtual keyboards are each displayed at a size in accordance with a small form factor device (e.g., a mobile phone); each of the first and second virtual keyboards is sized for a small form factor device but displayed at that size on a larger form factor device (e.g., a tablet computer).

The device detects (604) a first finger gesture (e.g., a tap gesture) on a first key in the first virtual keyboard. In response to detecting the first finger gesture on the first key in the first virtual keyboard, the device performs (606) an action corresponding to the first key in the first virtual keyboard. For example, in FIG. 5A, gesture 510 is detected on the “G” key in virtual keyboard 506. In response, the letter “g” is entered into input text 504.

The device detects (608) a second finger gesture (e.g., a tap gesture) on a second key in the second virtual keyboard. In response to detecting the second finger gesture on the second key in the second virtual keyboard, the device performs (610) an action corresponding to the second key in the second virtual keyboard. For example, in FIG. 5A, gesture 512 is detected on the “O” key in virtual keyboard 508. In response, letter “o” is entered into input text 504.

In some embodiments, the action corresponding to the key includes displaying visual feedback on the display. For example, if the gesture is a holding of a letter key in the virtual keyboard for a period of time, a pop-up with selectable alternate characters may be displayed, so that the user can select an alternate character presented in the pop-up. Such visual feedback is displayed in the proximity of the virtual keyboard where the corresponding gesture is detected. For example, if the gesture is detected on a key in keyboard 506, then the alternate characters pop-up is displayed in proximity of keyboard 506. In some embodiments, data (e.g., an additional bit) identifying the origin of a “keystroke” (the right-side keyboard or left-side keyboard) is included with the detected gesture input data so that the device can determine whether a detected gesture occurred on the right-side keyboard or the left-side keyboard.

In some embodiments, the second virtual keyboard is a duplicate of the first virtual keyboard (612). The device may display concurrently keyboards of the same type at the first location and at the second location. For example, in FIG. 5A, both keyboards 506 and 508 are QWERTY English keyboards. As another example, in FIG. 5F, both keyboards 522 and 524 are number/symbol keyboards.

In some embodiments, the first location is located at a first corner area on the touch-sensitive display, and the second location is located at a second corner area, opposite the first corner area, on the touch-sensitive display (614). For example, in FIG. 5A, the locations where keyboards 506 and 508 are displayed are corner areas 505 and 507, respectively. Corner area 505 is located at one corner of display 340. Corner area 507 is located at another corner of display 340, horizontally opposite to corner area 505.

In some embodiments, the first location is located at a first edge area adjacent to a first edge of the touch-sensitive display, and the second location is located at a second edge area adjacent to a second edge, opposite the first edge, of the touch-sensitive display (616). For example, in FIG. 5G, the locations where keyboards 506 and 508 are displayed are edge areas 525 and 527, respectively. Edge area 525 is adjacent to the left edge of display 340. Edge area 527 is adjacent to the right edge of display 340, with the right edge being horizontally opposite the left edge of display 340. The edge areas may be away from the corners of display 340. For example, edge areas 525 and 527 are each approximately halfway between the upper and lower corners on their respective sides of display 340.

In some embodiments, whether the first and second virtual keyboards are displayed at the corner areas or edge areas is based on whether the device is being held by hand at the lower end of the device or at approximately the middle of the device. The device may, based on readings from one or more sensors in the device (e.g., an accelerometer, gyro, or touch-sensitive surface on the device casing), determine that the device is being held by hand, with one or two hands holding the device at its lower end or around the middle of the device. The keyboards are displayed at locations that are in proximity of the determined locations of the hand grips. For example, if the device determines that the device is being held by hand at the lower end of the device, the keyboards are displayed at corner areas proximate to the lower end. If the device determines that the device is being held by hand at the middle of the device, the keyboards are displayed at edge areas proximate to the middle. In some embodiments, whether the virtual keyboards are displayed at corner areas or edge areas are determined by user-configurable settings.

In some embodiments, the displaying of the first virtual keyboard and the second virtual keyboard is performed in response to detecting a predefined gesture on the touch-sensitive display (618). For example, in FIG. 5C, while no keyboards are displayed, gesture 516 is detected. In response to detection of gesture 516, virtual keyboards 506 and 508 are displayed, as in FIG. 5D.

In some embodiments, the first finger gesture and the second finger gesture are detected in a sequence (620), and the action corresponding to the first key in the first virtual keyboard and the action corresponding to the second key in the second virtual keyboard are performed in an order in accordance with the sequence (622). In some embodiments, gestures detected on the keys of the first and second keyboards are detected in a single sequence, and the actions corresponding to the keys are performed in an order in accordance with the sequence, regardless of the keyboard on which the gesture was detected. For example, in some embodiments, input gestures detected on the keys of the first and second keyboard are queued into an input queue according to the sequence of detection, and the actions corresponding to the keys on which the gestures are detected are performed in accordance with the ordering in the queue; there are no separate queues for inputs from the first virtual keyboard and inputs from the second virtual keyboard. Thus, neither keyboard has priority over the other with respect to the timing of performance of actions corresponding to keys in one keyboard or the other; the timing of the performance is based on when the gesture was detected regardless of the keyboard on which the gesture was detected.

In some embodiments, the device detects (624) an input to change the first virtual keyboard to a third virtual keyboard. In response to detecting the input to change the first virtual keyboard to the third virtual keyboard, the device displays (626) the third virtual keyboard in place of the first virtual keyboard and concurrently maintains display of the second virtual keyboard. When an input to change one of the keyboards is detected, in some embodiments, only the keyboard associated with the input changes; the other keyboard stays the same. For example, in FIG. 5D, gesture 518 is detected on key 520 to change keyboard 508 into a number/symbols keyboard. In response, keyboard 508 changes to keyboard 522 but keyboard 506 stays the same, as shown in FIG. 5E. The process applies analogously if the detected input was an input to change the second keyboard; the second keyboard changes to a third keyboard in response to the detected input and the first keyboard remains as is.

In some embodiments, the third “virtual keyboard” is a handwriting recognition area. For example, in FIG. 5K, handwriting recognition field 534 is displayed in place of virtual keyboard 508 at corner area 507, while concurrently virtual keyboard 506 is displayed at corner area 505.

In some embodiments, the device detects (628) an input to change the first virtual keyboard to a third virtual keyboard. In response to detecting the input to change the first virtual keyboard to the third virtual keyboard, the device displays (630) the third virtual keyboard in place of the first virtual keyboard and concurrently displaying a duplicate of the third virtual keyboard in place of the second virtual keyboard. When an input to change one of the keyboards is detected, in some embodiments, both keyboards change. For example, in FIG. 5D, gesture 518 is detected on key 520 to change keyboard 508 into a number/symbols keyboard. In response, keyboards 506 and 508 change to keyboards 524 and 522, respectively, as shown in FIG. 5F. The process applies analogously if the detected input was an input to change the second keyboard; both keyboards change to a third keyboard in response to the detected input.

In some embodiments, the touch-sensitive display is oriented (632) in a first orientation. The device displays (634) concurrently the first virtual keyboard and the second virtual keyboard at respective sizes in accordance with the first orientation. For example, in FIG. 5A, display 340 is in the portrait orientation. Keyboards 506 and 508 are displayed at sizes in accordance with the portrait orientation of display 340; each of keyboards 506 and 508 is sized as if it is displayed on a small form factor device in portrait orientation.

In some embodiments, in response to detecting a change in the orientation of the touch-sensitive display from the first orientation to a second orientation, the device displays (636) concurrently the first virtual keyboard and the second virtual keyboard at respective sizes in accordance with the second orientation. For example, in FIG. 5J, display 340 is in the landscape orientation, changed from the portrait orientation as in FIG. 5A. Keyboards 506 and 508 are displayed at sizes in accordance with the landscape orientation of display 340; each of keyboards 506 and 508 is sized as if it is displayed on a small form factor device in landscape orientation.

Conversely, in some embodiments, in response to detecting a change in the orientation of the touch-sensitive display from the first orientation to a second orientation, the device displays (638) concurrently the first virtual keyboard and the second virtual keyboard at respective sizes in accordance with the first orientation. For example, in FIG. 5I, display 340 is in the landscape orientation, changed from the portrait orientation as in FIG. 5A. Keyboards 506 and 508 are displayed at sizes as if display 340 is still in portrait orientation.

In some embodiments, the device detects (640) that the device is resting on a surface. In response to detecting that the device is resting on the surface, the device ceases displaying (642) the first and second virtual keyboards, and displays (644) a third virtual keyboard, where the third virtual keyboard is wider than the first virtual keyboard or the second virtual keyboard. When the device is resting on a surface, a wider virtual keyboard is displayed instead of the first and second virtual keyboards; the wider virtual keyboard facilitates touch typing while the device is on a surface. In some embodiments, the third virtual keyboard spans the width of the display. For example, in FIG. 5H, virtual keyboard 528, which is wider than either keyboard 506 or 508, is displayed instead of keyboards 506 and 508 when device 300 is detected to be resting on a surface.

In some embodiments, while displaying the third virtual keyboard, the device detects (646) that the device is being held by hand. In response to detecting that the device is being held by hand, the device ceases displaying (648) the third virtual keyboard, and displays (650) concurrently the first virtual keyboard at the first location on the touch-sensitive display and the second virtual keyboard at the second location on the touch-sensitive display. When the device is being held by hand, two smaller virtual keyboards are displayed instead of the wider virtual keyboard; the two smaller virtual keyboards facilitates thumb typing while the device is held by hand. For example, when device 300 is detected to be held by hand (e.g., picked up by hand from a surface), virtual keyboard 528, shown in FIG. 5H ceases to be displayed, and keyboards 506 and 508 are displayed at corner areas 505 and 507, respectively, as in FIG. 5A.

The detection of whether the device is resting on a surface or being held by hand may be based on data from one or more sensors in the device (e.g., an accelerometer, or an LED based reflectometer on the back of the device). For example, a relatively steady accelerometer reading with acceleration perpendicular to the back of the case may indicate that the device is resting on a level surface, and relatively unsteady accelerometer readings with acceleration at an angle to the back of the case may indicate that the device is being held by hand. The addition of a reflectometer to indicate that reflected light from an LED light source on the back of the case is being sensed by an adjacent photodetector may be additionally used to increase the reliability of detecting whether the device is resting on a surface versus being held in the hand. Additionally, a touch sensitive surface on the back of the device (e.g., a touch-sensitive casing of the device) can be used to determine that the device is being held, and if so, detect the position of the hand or hands being used to hold the device.

In some embodiments, the first finger gesture is made by a first thumb on a first hand and the second finger gesture is made by a second thumb, distinct from the first thumb, on a second hand; when the first hand is supporting the device proximate to the first virtual keyboard, all keys in the first virtual keyboard are reachable by the first thumb of the first hand; and, when the second hand is supporting the device proximate to the second virtual keyboard, all keys in the second virtual keyboard are reachable by the second thumb of the second hand (652).

For example, in FIG. 5L, when left hand 536 is supporting device 300 (e.g., with fingers 536-A), left thumb 536-B can, contemporaneous with left hand 536 supporting device 300, reach (and activate) any of the keys in keyboard 506. When right hand 538 is supporting device 300 (e.g., with fingers 538-A), right thumb 538-B can, contemporaneous with right hand 538 supporting device 300, reach (and activate) any of the keys in keyboard 508.

In some embodiments, the first finger gesture is made by a first thumb on a first hand and the second finger gesture is made by a second thumb, distinct from the first thumb, on a second hand; and, when the first hand and the second hand are concurrently supporting the device, all keys in the first virtual keyboard are reachable by the first thumb of the first hand and all keys in the second virtual keyboard are reachable by the second thumb of the second hand (654).

For example, in FIG. 5L, when left hand 536 and right hand 538 are concurrently supporting device 300 (e.g., with fingers 536-A and 538-A), left thumb 536-B can reach (and activate) any of the keys in keyboard 506 and right thumb 538-B can reach (and activate) any of the keys in keyboard 508.

The operations in the information processing methods described above may be implemented by running one or more functional modules in information processing apparatus such as general purpose processors or application specific chips. These modules, combinations of these modules, and/or their combination with general hardware (e.g., as described above with respect to FIGS. 1A, 1B and 3) are all included within the scope of protection of the invention.

The operations described above with reference to FIGS. 6A-6D may be implemented by components depicted in FIGS. 1A-1C. For example, detecting operations 604, 608, and performing operations 606, 610 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 may utilize or call data updater 176, object updater 177 or GUI updater 178 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1C.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A multifunction device, comprising:
a touch-sensitive display;
one or more processors;
memory; and
one or more programs, wherein the one or more programs are stored in the memory and configured to be executed by the one or more processors, the one or more programs including instructions for:
displaying concurrently a first virtual keyboard at a first location on the touch-sensitive display and a second virtual keyboard at a second location, distinct from the first location, on the touch-sensitive display;
detecting a first finger gesture on a first key in the first virtual keyboard;
in response to detecting the first finger gesture on the first key in the first virtual keyboard, performing an action corresponding to the first key in the first virtual keyboard;
detecting a second finger gesture on a second key in the second virtual keyboard; and,
in response to detecting the second finger gesture on the second key in the second virtual keyboard, performing an action corresponding to the second key in the second virtual keyboard.

2. The device of claim 1, wherein the second virtual keyboard is a duplicate of the first virtual keyboard.

3. The device of claim 1, wherein:
the first location is located at a first corner area on the touch-sensitive display; and
the second location is located at a second corner area on the touch-sensitive display, wherein the second corner area is opposite the first corner area.

4. The device of claim 1, wherein:
the first location is located at a first edge area adjacent to a first edge of the touch-sensitive display; and
the second location is located at a second edge area adjacent to a second edge of the touch-sensitive display, wherein the second edge is opposite the first edge.

5. The device of claim 1, including instructions for:
in response to detecting a predefined gesture on the touch-sensitive display, displaying concurrently the first virtual keyboard at the first location on the touch-sensitive display and the second virtual keyboard at the second location, distinct from the first location, on the touch-sensitive display.

6. The device of claim 1, wherein the first finger gesture and the second finger gesture are detected in a sequence, the device including instructions for:
in response to detecting the first finger gesture on the first key and detecting the second finger gesture on the second key, performing the action corresponding to the first key in the first virtual keyboard and performing the action corresponding to the second key in the second virtual keyboard in accordance with the sequence.

7. The device of claim 1, including instructions for:
detecting an input to change the first virtual keyboard to a third virtual keyboard; and
in response to detecting the input to change the first virtual keyboard to the third virtual keyboard, displaying the third virtual keyboard in place of the first virtual keyboard and concurrently maintaining display of the second virtual keyboard.

8. The device of claim 1, including instructions for:
detecting an input to change the first virtual keyboard to a third virtual keyboard; and
in response to detecting the input to change the first virtual keyboard to the third virtual keyboard, displaying the third virtual keyboard in place of the first virtual keyboard and concurrently displaying a duplicate of the third virtual keyboard in place of the second virtual keyboard.

9. The device of claim 1, wherein the touch-sensitive display is oriented in a first orientation, the device including instructions for:
displaying the first virtual keyboard and the second virtual keyboard at respective sizes in accordance with the first orientation.

10. The device of claim 9, including instructions for:
in response to detecting a change in the orientation of the touch-sensitive display from the first orientation to a second orientation, displaying concurrently the first virtual keyboard and the second virtual keyboard at respective sizes in accordance with the second orientation.

11. The device of claim 9, including instructions for:
in response to detecting a change in the orientation of the touch-sensitive display from the first orientation to a second orientation, displaying concurrently the first virtual keyboard and the second virtual keyboard at respective sizes in accordance with the first orientation.

12. The device of claim 1, including instructions for:
detecting that the multifunction device is resting on a surface; and
in response to detecting that the multifunction device is resting on the surface:
ceasing to display the first and second virtual keyboards; and
displaying a third virtual keyboard, wherein the third virtual keyboard is larger than the first virtual keyboard or the second virtual keyboard.

13. The device of claim 12, including instructions for:
while displaying the third virtual keyboard, detecting that the multifunction device is being held by hand; and
in response to detecting that the multifunction device is being held by hand:
ceasing to display the third virtual keyboard;
displaying concurrently the first virtual keyboard at the first location on the touch-sensitive display and the second virtual keyboard at the second location on the touch-sensitive display.

14. The device of claim 1, wherein:
the first finger gesture is made by a first thumb on a first hand and the second finger gesture is made by a second thumb, distinct from the first thumb, on a second hand;
when the first hand is supporting the device proximate to the first virtual keyboard, all keys in the first virtual keyboard are reachable by the first thumb of the first hand; and,
when the second hand is supporting the device proximate to the second virtual keyboard, all keys in the second virtual keyboard are reachable by the second thumb of the second hand.

15. The device of claim 1, wherein:
the first finger gesture is made by a first thumb on a first hand and the second finger gesture is made by a second thumb, distinct from the first thumb, on a second hand; and,
when the first hand and the second hand are concurrently supporting the device, all keys in the first virtual keyboard are reachable by the first thumb of the first hand and all keys in the second virtual keyboard are reachable by the second thumb of the second hand.

16. A method, including:
at a multifunction device with a touch-sensitive display:
displaying concurrently a first virtual keyboard at a first location on the touch-sensitive display and a second virtual keyboard at a second location, distinct from the first location, on the touch-sensitive display;
detecting a first finger gesture on a first key in the first virtual keyboard;
in response to detecting the first finger gesture on the first key in the first virtual keyboard, performing an action corresponding to the first key in the first virtual keyboard;
detecting a second finger gesture on a second key in the second virtual keyboard; and,
in response to detecting the second finger gesture on the second key in the second virtual keyboard, performing an action corresponding to the second key in the second virtual keyboard.

17. The method of claim 16, wherein the second virtual keyboard is a duplicate of the first virtual keyboard.

18. The method of claim 16, wherein:
the first location is located at a first corner area on the touch-sensitive display; and
the second location is located at a second corner area on the touch-sensitive display, wherein the second corner area is opposite the first corner area.

19. A graphical user interface on a multifunction device with a touch-sensitive display, a memory, and one or more processors to execute one or more programs stored in the memory, the graphical user interface comprising:
a first virtual keyboard at a first location on the touch-sensitive display; and
a second virtual keyboard at a second location, distinct from the first location, on the touch-sensitive display;
wherein:
in response to detecting a first finger gesture on a first key in the first virtual keyboard, an action corresponding to the first key in the first virtual keyboard is performed; and
in response to detecting a second finger gesture on a second key in the second virtual keyboard, an action corresponding to the second key in the second virtual keyboard is performed.

20. A computer readable storage medium storing one or more programs, the one or more programs comprising instructions, which when executed by a multifunction device with a touch-sensitive display, cause the device to:
display concurrently a first virtual keyboard at a first location on the touch-sensitive display and a second virtual keyboard at a second location, distinct from the first location, on the touch-sensitive display;
detect a first finger gesture on a first key in the first virtual keyboard;
in response to detecting the first finger gesture on the first key in the first virtual keyboard, perform an action corresponding to the first key in the first virtual keyboard;
detect a second finger gesture on a second key in the second virtual keyboard; and,
in response to detecting the second finger gesture on the second key in the second virtual keyboard, perform an action corresponding to the second key in the second virtual keyboard.
